(19) United States
(12) Patent Application Publication
(10) Pub. No.: US 2011/0285838 A1
(43) Pub. Date: Nov. 24, 2011

(54) INFORMATION PROCESSING APPARATUS, INFORMATION PROCESSING METHOD, PROGRAM, IMAGING APPARATUS, AND IMAGING APPARATUS EQUIPPED WITH OPTICAL MICROSCOPE

(75) Inventors: Koichiro Kishima, Kanagawa (JP); Gakuho Fukushi, Tokyo (JP); Ryu Narusawa, Kanagawa (JP)

(73) Assignee: SONY CORPORATION, Tokyo (JP)

(21) Appl. No.: 13/102,232

(22) Filed: May 6, 2011

(30) Foreign Application Priority Data
May 19, 2010 (JP) P2010-115275
Jun. 28, 2010 (JP) P2010-146665

(51) Int. Cl. H04N 5/247; H04N 7/18

(52) U.S. Cl. 348/79; 348/264; 348/E05.048; 348/E07.085

(57) ABSTRACT

Provided is an information processing apparatus including a first setting unit and a second setting unit. The first setting unit sets position coordinates of first photography regions arranged along a first direction of two orthogonal axial directions so that the first photography regions adjacent to each other have first overlapping regions where the first photography regions overlap with each other in the first direction. The second setting unit sets position coordinates of second photography regions arranged along the first direction based on the position coordinates of the first photography regions so that the second photography regions adjacent to each other have second overlapping regions where the second photography regions overlap with each other in the first direction, the second photography regions overlap with the first photography regions in a second direction of the two axial directions, and the second overlapping regions are prevented from overlapping with the first overlapping regions.

### CROSS REFERENCES TO RELATED APPLICATIONS

The present application claims priority to Japanese Patent Application JP 2010-115275 filed in the Japanese Patent Office on May 19, 2010 and Japanese Patent Application JP 2010-146665 filed in the Japanese Patent Office on Jun. 28, 2010, the entire contents of which are being incorporated herein by reference.

### BACKGROUND

The present application relates to an information processing apparatus that can set shot layouts of a plurality of photography regions to be photographed for generation of a plurality of images to be subjected to a stitching process, an information processing method, a program, an imaging apparatus, and an imaging apparatus equipped with an optical microscope.

In the past, a stitching technique for connecting a plurality of images having physically continuous contents has been known, and is used for panoramic photography, photography of microscopic images and the like. For example, in a microscope system described in Japanese Patent Application Laid-Open No. 2007-65669 (hereinafter, referred to as Patent document 1), a microscopic slide placed under an objective lens of the microscope is photographed at each of plural regions. Image blocks as the images on the photographed regions are suitably connected to each other by using a normalized correlation function. As a result, an image in which the microscopic slide is enlarged is created (see paragraph [0065] and the like in Patent Document 1).

FIG. 3 in Patent Document 1 illustrates a method of photographing four image blocks 501 to 504 to be connected to each other by the stitching technique. First, the image block 501 is photographed. A stage on which the microscopic slide is placed transfers along an x axial direction with respect to the objective lens of the microscope, and the image block 502 having a region overlapping with the image block 501 is photographed. The stage then transfers along a y axial direction, and the image block 503 having a region overlapping with the image block 502 is photographed. Finally, the image block 504 is photographed. The image block 504 overlaps with the image block 503 in the x axial direction and overlaps with the image block 501 in the y axial direction. The image blocks 501 and 502 compose a row 1, and the image blocks 503 and 504 compose a row 2 (see paragraphs [0050]-[0055] and the like in Patent Document 1).

### SUMMARY

For example, a case is considered where the stitching technique described in Patent Document 1 is used when excitation light is emitted to a sample on the stereoscopic slide and a fluorescence phenomenon of the sample is photographed by using a fluorescence microscope. In that case, every time the respective image blocks are photographed, the excitation light is emitted redundantly to a portion of the sample corresponding to an overlapping region between the plurality of adjacent image blocks. As a result, a portion of the sample to which the excitation light is emitted redundantly is deteriorated due to discoloration.

In view of the above-mentioned circumstances, there is a need for providing an information processing apparatus that can generate a plurality of images to be subjected to a stitching process while a deterioration in a sample to be photographed is being suppressed, an information processing method, a program, an imaging apparatus, and the imaging apparatus equipped with an optical microscope.

According to one embodiment, there is provided an information processing apparatus including a first setting means and a second setting means.

The first setting means sets respective position coordinates of a plurality of first photography regions arranged along a first direction of two axial directions orthogonal to each other, which are photographed by an imaging means capable of photographing the photography regions having predetermined sizes in the two axial directions, so that the first photography regions adjacent to each other have first overlapping regions where the first photography regions overlap with each other in the first direction.

The second setting means sets respective position coordinates of a plurality of second photography regions arranged along the first direction based on the position coordinates of the plurality of first photography regions, which are set by the first setting means, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

According to one embodiment, there is provided an information processing apparatus including a first setting unit and a second setting unit.

The first setting unit sets respective position coordinates of a plurality of first photography regions arranged along a first direction of two axial directions orthogonal to each other, which are photographed by an imaging unit capable of photographing the photography regions having predetermined sizes in the two axial directions, so that the first photography regions adjacent to each other have first overlapping regions where the first photography regions overlap with each other in the first direction.

The second setting unit sets respective position coordinates of a plurality of second photography regions arranged along the first direction based on the position coordinates of the plurality of first photography regions, which are set by the first setting unit, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

In the information processing apparatus, the imaging means can photograph the plurality of first photography regions overlapping with each other in the first direction and the plurality of second photography regions overlapping with each other in the first direction. The position coordinates of the plurality of first and second photography regions are set so that the plurality of first and second photography regions overlap with each other in the second direction and the first and second overlapping regions are prevented from overlapping with each other. Therefore, for example, when excitation light or the like is emitted to the photography regions at the time of photographing the photography regions, a cumulative amount of the excitation light emitted redundantly to the first and second overlapping regions can be reduced. As a result, since the plurality of photography regions can be photographed while deterioration in a sample to be photographed is being suppressed, images of the plurality of photography regions to be subjected to the stitching process can be created.

The information processing apparatus may further include a detecting means that can detect a position coordinate of an edge portion of a subject to be photographed by the imaging means.

In this case, the second setting means may set a position coordinate of a standard photography region being one of the plurality of the second photography regions based on the position coordinate of the edge portion detected by the detecting means, and may set respective position coordinates of the plurality of second photography regions based on the position coordinate of the standard photography region.

In the information processing apparatus, the position coordinate of the edge portion of the subject to be photographed by the imaging means is detected. The second setting means sets the position coordinate of the standard photography region based on the position coordinate of the edge portion. Therefore, the suitable setting of the position coordinate of the standard photography region enables the plurality of first and second photography regions to be photographed in a short processing time.

The information processing apparatus may further include a selecting means and a comparing means.

The selecting means selects one of a first direction setting pattern in which the first direction is set as a vertical direction and the second direction is set as a horizontal direction, and a second direction setting pattern in which the first direction is set as the horizontal direction and the second direction is set as the vertical direction.

The comparing means compares a period of time for photographing the plurality of first and second photography regions whose position coordinates are set to include the position coordinate of the edge portion of the subject detected by the detecting means when the selecting means selects the first direction setting pattern with a period of time for photographing the plurality of first and second photography regions whose position coordinates are set to include the position coordinate of the edge portion of the subject detected by the detecting means when the selecting means selects the second direction setting pattern.

In the information processing apparatus, one of the first and second direction setting patterns can be selected. A period of time for photographing the plurality of first and second photography regions in the first direction setting pattern is compared with that in the second direction setting pattern. As a result, the direction setting pattern in which photography time of the plurality of first and second photography regions is shorter is suitably selected so that the plurality of first and second photography regions can be photographed in a short processing time.

According to one embodiment, there is provided an information processing method executed by the information processing apparatus as follows.

That is to say, the information processing apparatus sets respective position coordinates of a plurality of first photography regions arranged along a first direction of two axial directions orthogonal to each other, which are photographed by an imaging means capable of photographing the photography regions having predetermined sizes in the two axial directions, so that the first photography regions adjacent to each other have first overlapping regions where the first photography regions overlap with each other in the first direction.

Respective position coordinates of a plurality of second photography regions arranged along the first direction are set based on the respective set position coordinates of the plurality of first photography regions so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

According to one embodiment, there is provided a program causing an information processing apparatus to execute the above-mentioned information processing method. The program may be recorded in a recording medium.

According to one embodiment, there is provided an imaging apparatus including an imaging means, a first setting means, and a second setting means.

The imaging means can photograph photography regions having predetermined sizes in two axial directions orthogonal to each other.

The first setting means sets respective position coordinates of a plurality of first photography regions arranged along a first direction of the two axial directions, which are photographed by the imaging means, so that the first photography regions adjacent to each other have first overlapping regions where the first photography regions overlap with each other in the first direction.

The second setting means sets respective position coordinates of a plurality of second photography regions arranged along the first direction based on the respective position coordinates of the plurality of first photography regions, which are set by the first setting means, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

According to one embodiment, there is provided an imaging apparatus including an imaging unit, a first setting unit, and a second setting unit.

The imaging unit can photograph photography regions having predetermined sizes in two axial directions orthogonal to each other.

The first setting unit sets respective position coordinates of a plurality of first photography regions arranged along a first direction of the two axial directions, which are photographed by the imaging unit, so that the first photography regions adjacent to each other have first overlapping regions where the first photography regions overlap with each other in the first direction.

The second setting unit sets respective position coordinates of a plurality of second photography regions arranged along the first direction based on the respective position coordinates of the plurality of first photography regions, which are set by the first setting unit, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

According to one embodiment, there is provided an imaging apparatus equipped with an optical microscope including an optical microscope, an imaging means, a transfer controlling means, a first setting means, a second setting means, and an output means.

The optical microscope includes an illumination optical system, a stage that has an observation region provided onto an optical path of the illumination optical system and is movable in two axial directions orthogonal to each other, and an imaging optical system that images photography regions arranged within the observation region and having predetermined sizes in the two axial directions.

The imaging means can photograph images of the photography regions imaged by the imaging optical system.

The transfer controlling means controls transfer of the stage in order to change positions of the photography regions with respect to the observation region.

The first setting means sets respective position coordinates of a plurality of first photography regions arranged along a first direction of the two axial directions, which are imaged by the imaging optical system, so that the first photography regions adjacent to each other have first overlapping regions where the first photography regions overlap with each other in the first direction.

The second setting means sets respective position coordinates of a plurality of second photography regions arranged along the first direction based on the respective position coordinates of the plurality of first photography regions, which are set by the first setting means, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

The output means outputs information about the respective position coordinates of the plurality of first photography regions, which are set by the first setting means, and information about the respective position coordinates of the plurality of second photography regions, which are set by the second setting means to the transfer controlling means.

According to one embodiment, there is provided an information processing apparatus including a first setting means and a second setting means.

The first setting means sets respective position coordinates of first photography regions and second photography regions arranged in a first direction of two axial directions orthogonal to each other, which are photographed by an imaging means capable of photographing photography regions having predetermined sizes in the two axial directions, so that the first and second photography regions have first overlapping regions where the first and second photography regions overlap with each other in the first direction, and respective position coordinates of the first and second photography regions in a second direction of the two axial directions, which is different from the first direction, are different from each other.

The second setting means sets respective position coordinates of third photography regions and fourth photography regions arranged in the first direction based on the respective position coordinates of the first and second photography regions, which are set by the first setting means, so that the third and fourth photography regions have second overlapping regions where the third and fourth photography regions overlap with each other in the first direction, the third and fourth photography regions overlap with the first and second photography regions in the second direction on third overlapping regions, and respective position coordinates of the third and fourth photography regions in the second direction are made to be different from each other, to thereby prevent the first, second, and third overlapping regions from overlapping with each other.

According to one embodiment, there is provided an information processing apparatus including a first setting unit and a second setting unit.

The first setting unit sets respective position coordinates of first photography regions and second photography regions arranged in a first direction of two axial directions orthogonal to each other, which are photographed by an imaging unit capable of photographing photography regions having predetermined sizes in the two axial directions, so that the first and second photography regions have first overlapping regions where the first and second photography regions overlap with each other in the first direction, and respective position coordinates of the first and second photography regions in a second direction of the two axial directions, which is different from the first direction, are different from each other.

The second setting unit sets respective position coordinates of third photography regions and fourth photography regions arranged in the first direction based on the respective position coordinates of the first and second photography regions, which are set by the first setting unit, so that the third and fourth photography regions have second overlapping regions where the third and fourth photography regions overlap with each other in the first direction, the third and fourth photography regions overlap with the first and second photography regions in the second direction on third overlapping regions, and respective position coordinates of the third and fourth photography regions in the second direction are made to be different from each other, to thereby prevent the first, second, and third overlapping regions from overlapping with each other.

In the information processing apparatus, the position coordinates of the first and second photography regions overlapping with each other on the first overlapping regions and the third and fourth photography regions overlapping with each other on the second overlapping regions are set. The first and second photography regions and the third and fourth photography regions overlap with each other on the third overlapping regions. The respective position coordinates of the first and second photography regions in the second direction are different from each other, and the respective position coordinates of the third and fourth photography region in the second direction are different from each other. As a result, the respective position coordinates can be set so that the first, second, and third overlapping regions are prevented from overlapping with each other. As a result, the cumulative amount of the excitation light to be emitted to the overlapping regions redundantly can be reduced. The plurality of photography regions can be photographed while the deterioration in the sample to be photographed is being suppressed.

According to one embodiment, there is provided an information processing method to be executed by the information processing apparatus as follows.

That is to say, the information processing apparatus sets respective position coordinates of first photography regions and second photography regions arranged in a first direction of two axial directions orthogonal to each other, which are photographed by an imaging means capable of photographing photography regions having predetermined sizes in the two axial directions, so that the first and second photography regions have first overlapping regions where the first and second photography regions overlap with each other in the first direction, and respective position coordinates of the first and second photography regions in a second direction of the two axial directions, which is different from the first direction, are different from each other.

The information processing apparatus sets respective position coordinates of third photography regions and fourth photography regions arranged in the first direction based on the respective position coordinates of the first and second photography regions, which are set by the first setting means, so that the third and fourth photography regions have second overlapping regions where the third and fourth photography regions overlap with each other in the first direction, the third and fourth photography regions overlap with the first and second photography regions in the second direction on third overlapping regions, and respective position coordinates of the third and fourth photography regions in the second direction are made to be different from each other, to thereby prevent the first, second, and third overlapping regions from overlapping with each other.

According to one embodiment, there is provided a program causing the information processing apparatus to execute the above-mentioned information processing method. The program may be recorded in a recording medium.

The information processing apparatus may further include a changing unit and a determining unit.

The changing unit can change sizes of the photography region in the two axial directions.

The determining unit determines whether a subject to be photographed by the imaging means is present on the edge portions of the photography regions.

In this case, when the determining unit determines that the subject is not present on the edge portion of the first overlapping region among the edge portions of the first photography regions, the changing unit may reduce the size of the second photography region in the first direction so that the first and the second photography regions do not have the first overlapping region.

When the subject is not present on the edge portion of the first overlapping region, the first and second photography regions are photographed not to have the first overlapping regions. Even if the generated images are connected without overlapping, the subject is suitably expressed. Therefore, when the changing unit appropriately sets the size of the second photography regions and appropriately sets presence/non-presence of the first overlapping regions, the regions to which the excitation light or the like is emitted redundantly can be reduced.

When the subject is photographed at a first focal point and a second focal point different from the first focal point by an imaging means, the first setting means may set position coordinates of the first and second photography regions at the time of photography at the first focal point and second focal point so that the first overlapping regions at the time of the photography at the first focal point and the first overlapping regions at the time of photography at the second focal point are not arranged on the same position.

In this case, the second setting means may set position coordinates of the third and the fourth photography regions at the time of the photography at the first and second focal points so that the second and third overlapping regions at the time of photography at the first focal point are not arranged on the same position as those of the second and third overlapping regions at the time of photography at the second focal point.

As a result, when one subject is photographed a plurality of times at different focal points, the excitation light or the like is prevented from being emitted intensively to specified regions of the subject. As a result, the deterioration in the sample to be photographed can be suppressed.

According to the embodiments of the present application, while the deterioration in a sample to be photographed is being suppressed, a plurality of images to be subjected to the stitching process can be generated.

Additional features and advantages are described herein, and will be apparent from the following Detailed Description and the figures.

### BRIEF DESCRIPTION OF THE FIGURES

FIG. 1 is a block diagram illustrating a constitutional example of an imaging system including an information processing apparatus according to a first embodiment;

FIG. 2 is a diagram schematically illustrating constitutions of an optical microscope and an imaging apparatus shown in FIG. 1;

FIG. 3 is a block diagram illustrating a constitutional example of the imaging apparatus shown in FIG. 1;

FIG. 4 is a block diagram illustrating a constitutional example of a PC according to the first embodiment;

FIG. 5 is a diagram describing a stitching process for a digital image for describing an operation of the PC according to the first embodiment;

FIG. 6 is a flowchart illustrating an outline of a method of setting shot layouts according to the first embodiment;

FIG. 7 are pattern diagrams for describing respective steps of the flowchart shown in FIG. 6;

FIG. 8 are pattern diagrams for describing respective steps of the flowchart shown in FIG. 6;

FIG. 9 are diagrams for describing a shot layout of a plurality of photography regions as a comparative example;

FIG. 10 is a diagram illustrating a cumulative light intensity on overlapping regions on the shot layout of the first and second photography regions according to the first embodiment;

FIG. 11 are diagrams illustrating the cumulative light intensity on overlapping regions on the shot layout of the photography regions as a comparative example;

FIG. 12 is a pattern diagram for describing a shot layout of photography regions determined by the PC control according to a second embodiment;

FIG. 13 is a flowchart illustrating an outline of a method of setting the shot layout of the photography regions in the information processing apparatus according to a third embodiment;

FIG. 14 are pattern diagrams for describing respective steps in the flowchart shown in FIG. 13;

FIG. 15 are pattern diagrams illustrating an example of the shot layout of the plurality of photography regions according to another embodiment;

FIG. 16 is a diagram schematically illustrating a functional block of a CPU in the PC according to a fourth embodiment;

FIG. 17 is a flowchart illustrating an outline of a method of setting the shot layout of the photography regions in the information processing apparatus according to the fourth embodiment;

FIG. 18 is a pattern diagram for describing respective steps in the flowchart shown in FIG. 17;

FIG. 19 is a diagram illustrating one example of the shot layout of the photography regions according to the fourth embodiment;

FIG. 20 is a data flow chart illustrating flows of various data in the imaging system including the PC according to a fifth embodiment;

FIG. 21 is a flowchart illustrating an outline of the method of setting the shot layout of the photography regions in the information processing apparatus according to the fifth embodiment;

FIG. 22 is a pattern diagram for describing respective steps in the flowchart shown in FIG. 21;

FIG. 23 are pattern diagrams for describing the respective steps in the flowchart shown in FIG. 21;

FIG. 24 is a flowchart illustrating a flow of a process for determining whether a cell is present on a boundary of the photography regions and changing a size of the photography regions;

FIG. 25 is a flowchart illustrating an outline of a method of setting the shot layout of the photography regions in the information processing apparatus according to a sixth embodiment; and

FIG. 26 is a pattern diagram for describing respective steps in the flowchart shown in FIG. 25.

### DETAILED DESCRIPTION

Embodiments of the present application will be described below in detail with reference to the drawings.

### First Embodiment

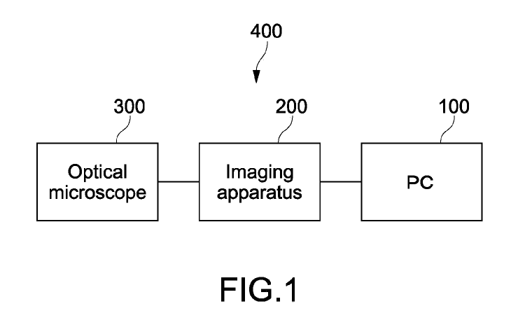

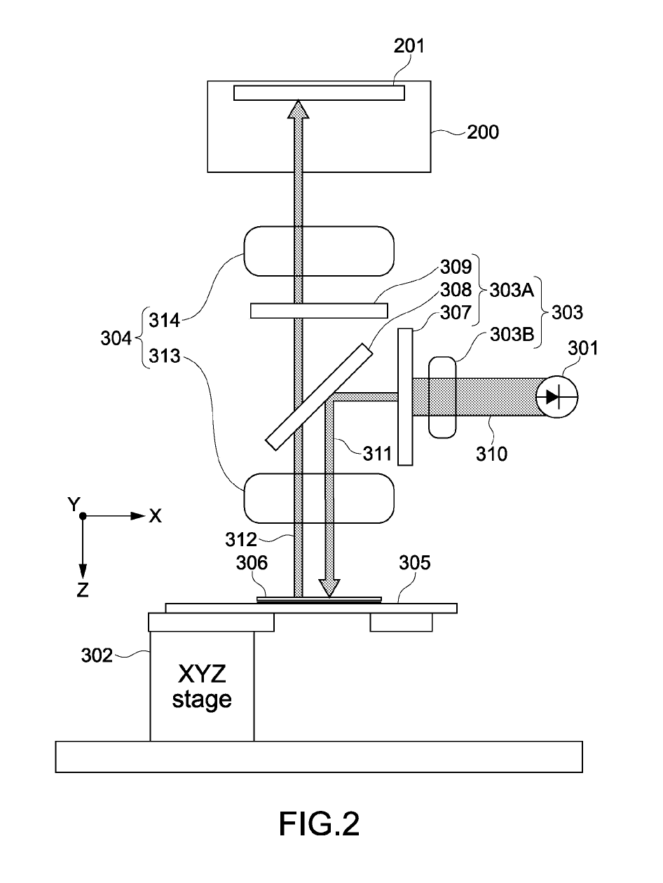

FIG. 1 is a block diagram illustrating a constitutional example of an imaging system including an information processing apparatus according to a first embodiment. FIG. 2 is a diagram schematically illustrating constitutions of an optical microscope and an imaging apparatus shown in FIG. 1. The imaging system 400 includes an optical microscope 300, an imaging apparatus 200 as an imaging means, and a Personal Computer (PC) 100 as the information processing apparatus.

The optical microscope 300 includes a light source 301 such as Light Emitting Diode (LED), an XYZ stage 302, an illumination lens 303B, an imaging lens 314, an objective lens 313, and a filter unit 303A.

An observation region 305 positioned on an optical path of an illumination optical system 303 including the illumination lens 303B is provided onto the XYZ stage 302. A sample 306 as an object to be observed is placed on the observation region 305. The sample 306 according to the first embodiment is, for example, a pathological specimen, and is formed into a preparation shape by applying thinly-sliced human organ and tissue to a glass slide. The sample 306 is fluorescently-stained with fluorescent pigment such as DAPI (4′,6-diamidino-2-phenylindole dihydrochloride).

The XYZ stage 302 can transfer in an X axial direction and a Y axial direction that are two axial directions orthogonal to each other in a plane direction where the sample 306 is placed. Further, the XYZ stage 302 can transfer to a Z axial direction that is an optical axial direction with respect to the illumination lens 303B. The transfer of the XYZ stage 302 is controlled by a transfer controlling means of the imaging apparatus 200 based on control by means of the PC 100.

The filter unit 303A includes an excitation filter 307, a dichroic mirror 308, and an absorption filter 309. The excitation filter 307 limits light 310 emitted from the light source 301 only to light with an excitation wavelength for exciting the fluorescent pigment in the sample 306, so as to generate excitation light 311. The dichroic mirror 308 reflects the excitation light 311 entering through the excitation filter 307 so that the sample 306 is irradiated with the excitation light 311. Further, the dichroic mirror 308 transmits fluorescence 312 generated by a fluorescent phenomenon of the sample 306 irradiated with the excitation light 311. The absorption filter 309 blocks light with wavelengths other than that of the fluorescence 312 so that only the fluorescence 312 enters the imaging apparatus 200.

An imaging optical system 304 includes the objective lens 313 and the imaging lens 314. This imaging optical system 304 allows an image of the sample 306 placed on the observation region 305 to be imaged.

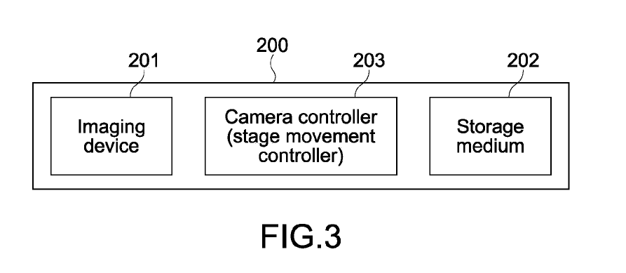

FIG. 3 is a block diagram illustrating a constitutional example of the imaging apparatus 200.

The imaging apparatus 200 includes an imaging device 201, a storage medium 202, and a camera controller 203. Examples of the imaging device 201 include a Charge Coupled Device (CCD) and a Complementary Metal Oxide Semiconductor (CMOS). An optical image of the observation region 305 imaged by the optical microscope 300 is formed on an imaging surface of the imaging device 201. An image of the observation region 305 is generated as Raw data. Examples of the size of generated image include 60×40 (K pixel), 50×50 (K pixel), and 4048×3040 (pixel).

The storage medium 202 may be, for example, a Dynamic Random Access Memory (DRAM), and functions as a buffer for retaining an image read from the imaging device 201. Examples of the storage medium 202 include a memory card, an optical disc, and a magneto-optical disc.

A camera controller 203 is constituted as, for example, Field Programmable Gate Array (FPGA), and contains a logical circuit. This camera controller 203 controls all the blocks of the imaging apparatus 200, and the image of the observation region 305 retained in the storage medium 202 is loaded into the PC 100. In the first embodiment, the camera controller 203 controls operations of the light source 301 and the XYZ stage 302 under the control of the PC 100. Alternatively, a control box dedicated to the XYZ stage 302 may be separately provided.

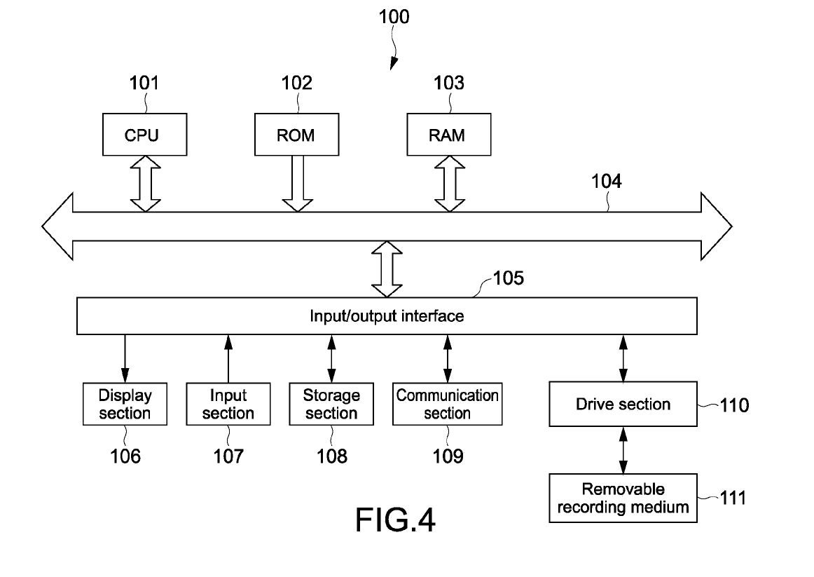

FIG. 4 is a block diagram illustrating a constitutional example of the PC 100 as the information processing apparatus according to the first embodiment.

The PC 100 includes a Central Processing Unit (CPU) 101, a Read Only Memory (ROM) 102, a Random Access Memory (RAM) 103, an input/output interface 105, and a bus 104 for connecting them.

The input/output interface 105 is connected to a display section 106, an input section 107, a storage section 108, a communication section 109, a drive section 110 and the like.

The display section 106 is a display device using, for example, liquid crystal, Electro-Luminescence (EL), or Cathode Ray Tube (CRT).

Examples of the input section 107 include a pointing device, a keyboard, a touch panel, and another operation device. When the input section 107 includes a touch panel, the touch panel can be integral with the display section 106.

The storage section 108 is a nonvolatile storage device, and examples thereof include a Hard Disk Drive (HDD), a flash memory, and another solid-state memory.

The drive section 110 is a device that can drive a removable recording medium 111 such as an optical recording medium, a floppy (registered trade name) disc, a magnetic recording tape, and a flash memory. Whereas the storage section 108 is frequently used as a device that is mounted to the PC 100 in advance in order to drive a non-removable recording medium.

The communication section 109 is a modem, a router, or another communication device that can be connected to a Local Area Network (LAN), a Wide Area Network (WAN) or the like, for communicating with other devices. The communication section 109 may establish communication using any one of a wire and a radio. The communication section 109 is frequently used separately from the PC 100.

The PC 100 processes image data output from the imaging apparatus 200. The data process by the PC 100 is realized by the cooperation of software stored in the storage section 108 or the ROM 102 and hardware sources of the PC 100. Concretely, the CPU 101 loads the program composing the software stored in the storage section 108 or the ROM 102 into the RAM 103 and executes the program to realize various data processes.

Operation of Information Processing Apparatus

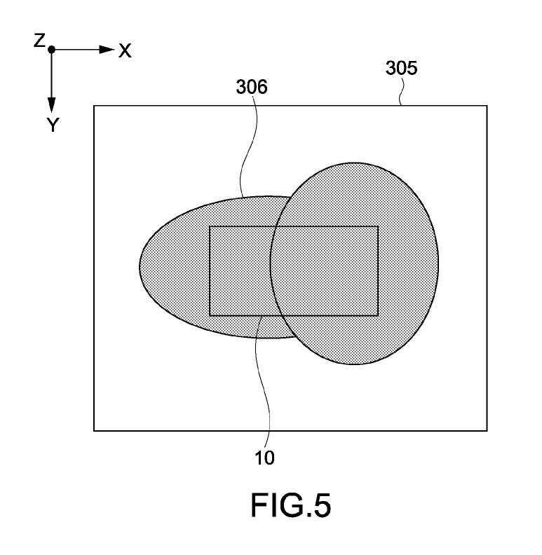

The operation of the PC 100 as the information processing apparatus according to the first embodiment will be described. First, the stitching process for a digital image will be described. FIG. 5 is a diagram for describing this process.

For example, in order to circumstantially observe the sample 306 placed on the observation region 305 of the optical microscope 300, an image of the sample 306 enlarged with high magnification is occasionally photographed by the imaging apparatus 200. In this case, a photography region 10 that is a part of the observation region 305 is imaged as shown in FIG. 5 and its image is photographed by the imaging apparatus 200. A plurality of photography regions 10 are arranged to entirely cover the sample 306 based on a predetermined shot layout. Images of the plurality of photography regions 10 generated by the imaging apparatus 200 are loaded into the PC 100 and are subjected to the stitching process in the PC 100 so that one image showing the sample 306 is generated.

The photography regions 10, as shown in FIG. 5, have respective predetermined sizes in the X axial direction and the Y axial direction that are the two orthogonal axial directions. In the first embodiment, the Y axial direction is determined as a first direction of the two orthogonal axial directions, and the X axial direction is determined as a second direction. Further, the Y axial direction as the first direction viewed in FIG. 5 is determined as a vertical direction, and the X axial direction as the second direction is determined as a horizontal direction. The sizes of the photography regions 10 in the two axial directions may be appropriately set by the magnification determined by the imaging optical system 304 of the optical microscope 300.

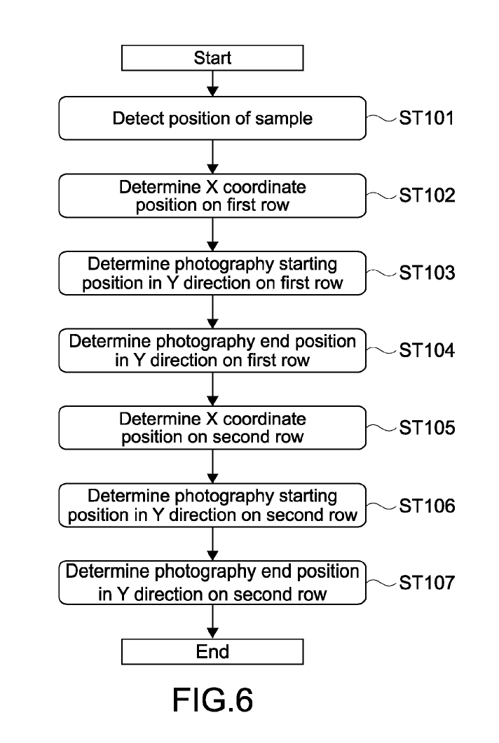

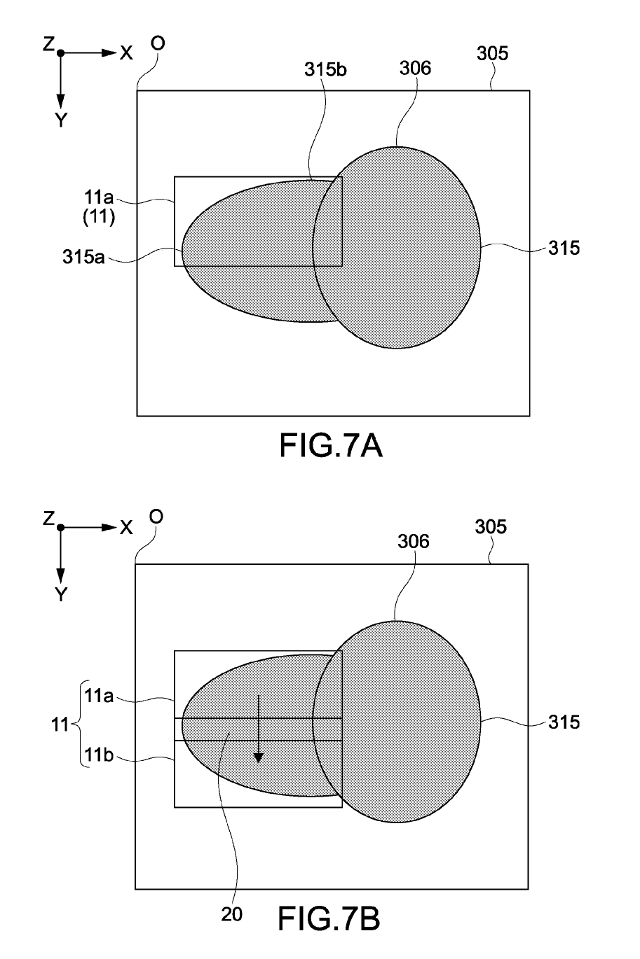

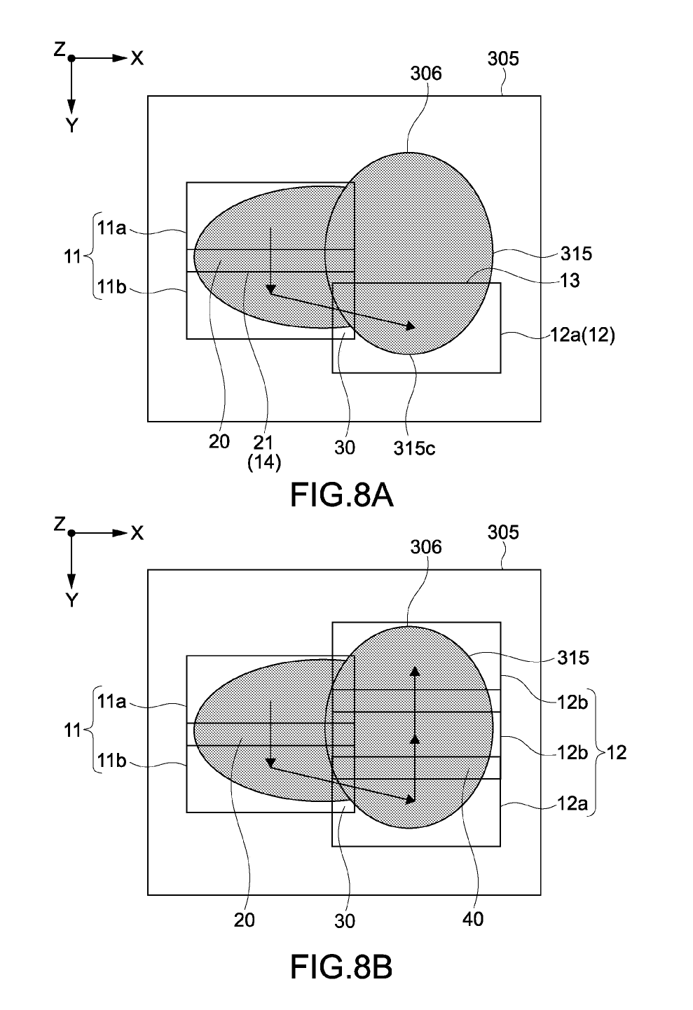

In the first embodiment, the PC 100 controls the operations of the optical microscope 300 and the imaging apparatus 200, and sets the shot layout of the plurality of photography regions 10 to be photographed. FIG. 6 is a flowchart illustrating an outline of the method of setting the shot layout according to the first embodiment. FIG. 7A to FIG. 8B are pattern diagrams for describing respective steps of the flowchart shown in FIG. 6.

The CPU 101 of the PC 100 detects a position of the sample 306 to be photographed by the imaging apparatus 200 (step 101). For example, the magnification of the imaging optical system 304 of the optical microscope 300 is suitably set, and the entire observation region 305 is imaged. The imaging apparatus 200 generates the image of the entire observation region 305 so as to be output to the PC 100. The CPU 101 of the PC 100 detects the position of the sample 306 placed on the observation region 305 based on the output image of the entire observation region 305. Alternatively, the CPU 101 generates a thumbnail image of the entire sample 306, and may detect the position of the sample 306 based on this thumbnail image. Any process may be used for detecting the position of the sample 306.

In the first embodiment, a position coordinate of an edge portion 315 of the sample 306 is detected at step 101. As the position coordinate, a position coordinate based on an upper left point O of the observation region 305 viewed in FIGS. 7A and 7B, may be used or a position coordinate based on another point may be used, for example.

An x coordinate position of a plurality of first photography regions 11 arranged along the Y axial direction is determined on a first row (step 102). A photography starting position in the Y axial direction is determined on the first row (step 103). As the result, among the plurality of first photography regions 11 arranged along the Y axial direction, an x coordinate and a y coordinate of a first photography region 11a photographed first are determined as the first row. In the first embodiment, a position coordinate of a center point of the first photography region 11a is determined as the position coordinate of the first photography region 11a. However, a position coordinate of another point, such as an end point on an upper left of the first photography region 11a, may be determined as the position coordinate of the first photography region 11a.

As shown in FIG. 7A, in the first embodiment, a position coordinate of an edge portion 315a on a leftmost position in the X axial direction is determined based on the detected position coordinate of the edge portion 315 of the sample 306. The x coordinate position of a photography position on the first row is determined so that the edge portion 315a is included in the plurality of first photography regions 11 arranged in the Y axial direction. Further, when the plurality of first photography regions 11 are arranged on the first row, a photography starting position in the Y axial direction on the first row is determined so that an edge portion 315b on a top end is included in a range covered by the first photography regions 11. As a result, the plurality of photography regions can be efficiently photographed over the entire sample 306 ranging from a left region to a right region of the sample 306.

The x coordinate position of the photography position on the first row may be determined so as to include not the edge portion 315a on the left end of the sample 306 but a right end portion viewed from FIGS. 7A and 7B. Alternatively, the photography of the first photography regions 11 arranged on the first row may be started on not both end portions of the sample 306 in the X axial direction but a center portion of the sample 306.

As shown in FIG. 7B, the position coordinate of the first photography region 11b arranged with the first photography region 11a along the Y axial direction is determined. At this time, the first photography region 11b and the first photography region 11a firstly photographed have a first overlapping region 20 in the Y axial direction as the first direction. The first overlapping region 20 has a size that is, for example, 5% to 20% of the photography region 11a (or the photography region 10) in the Y axial direction. However, the size is not limited to this range, and may be appropriately set within a range in which the stitching process is suitably executed.

A photography end position in the Y axial direction on the first row is determined (step 104). The photography end position may be determined in advance based on, for example, the position coordinate of the edge portion 315 of the sample 306 detected at step 101. Alternatively, when the first photography regions 11 are sequentially photographed on the first row and at the time when the first photography region 11 does not include the sample 306, a position coordinate of the first photography region 11 photographed second to last may be determined as the photography end position.

The x coordinate positions of a plurality of second photography regions 12 arranged along the Y axial direction on a second row is determined (step 105). The x coordinate position of a photography position on the second row is determined so that the plurality of second photography regions 12 arranged on the second row overlap with the plurality of first photography regions 11 arranged on the first row in the X axial direction as the second direction. A size of overlapping regions 30 between the plurality of first photography regions 11 and the plurality of second photography regions 12 in the X axial direction may be the same as or different from that of the first overlapping region 20 in the Y axial direction.

A photography starting position in the Y axial direction on the second row is determined (step 106). As a result, as shown in FIG. 8A, among the plurality of second photography regions 12 arranged along the Y axial direction as the second row, a position coordinate of a standard photography region 12a (x coordinate and y coordinate) is determined.

A condition at the time when the position coordinate of the standard photography region 12a is determined will be described. As shown in FIG. 8B, a plurality of second photography regions 12b are arranged along the Y axial direction as the first direction so as to be alongside the standard photography region 12a. The plurality of second photography regions 12b as well as the standard photography region 12a are arranged so as to have second overlapping regions 40 where the adjacent second photography regions 12b overlap with each other in the Y axial direction. The position coordinate of the standard photography region 12a is determined so that these second overlapping regions 40 are prevented from overlapping with the first overlapping regions 20 arranged on the first row.

For example as shown in FIG. 8A, it is sufficient that the position coordinate of the standard photography region 12a be set so that an upper side 13 of the standard photography region 12a is on a position in the Y axial direction lower than a lower side 21 of the first overlapping regions 20 of the first photography regions 11b adjacent in the X axial direction. In other words, the upper side 13 of the standard photography region 12a may be positioned lower than the lower side 14 of the first photography region 11a overlapping with the adjacent first photography region 11b.

It is sufficient that the position coordinate of the standard photography region 12a be determined so that a predetermined gap is provided between the lower side 21 of the first overlapping region 20 and the upper side 13 of the standard photography region 12a. As a result, the first and second overlapping regions 20 and 40 can be prevented from overlapping by design tolerance of the illumination lens 303B and the objective lens 313 of the optical microscope 300, or an error of positioning accuracy of the XYZ stage 302.

In the first embodiment, when the plurality of second photography regions 12 are arranged on the x coordinate position on the second row determined at step 105, the position coordinate of an edge portion 315c positioned on a lowermost end in the range covered by the plurality of second photography regions 12 is determined. The position coordinate of the standard photography region 12a is determined so that the edge portion 315c is included in the standard photography region 12a.

When the position coordinate of the standard photography region 12a is determined, the respective position coordinates of the plurality of second photography regions 12b arranged on the second row are determined based on the position coordinate of the standard photography region 12a. In the first embodiment, the second overlapping regions 40 are set so as to have a constant size. However, the size of the second overlapping regions 40 may not have to be constant as long as the first and second overlapping regions 20 and 40 do not overlap with each other.

A photography end position in the Y axial direction on the second row is determined (step 107). The photography end position on the second row may be determined similarly to the photography end position on the first row determined at step 104.

In the first embodiment, an entire shape of the sample 306 is covered by the plurality of first photography regions 11 arranged on the first row and the plurality of second photography regions 12 arranged on the second row. However, a plurality of photography regions may be arranged on a third row based on the size of the sample 306 so as to overlap with the plurality of second photography regions 12b arranged on the second row. In this case, the plurality of photography regions may be arranged on the third row so that overlapping regions of the plurality of photography regions arranged on the third row are prevented from overlapping with the second overlapping regions 40 on the second row.

For example, the CPU 101 may calculate the number of rows necessary for covering the entire sample 306 when the position coordinate of the edge portion 315 of the sample 306 is detected at step 101. Alternatively, when the photography end positions on the respective rows are determined and the photography on each row is completed, it may be determined whether the sample is present on a region adjacent to that row.

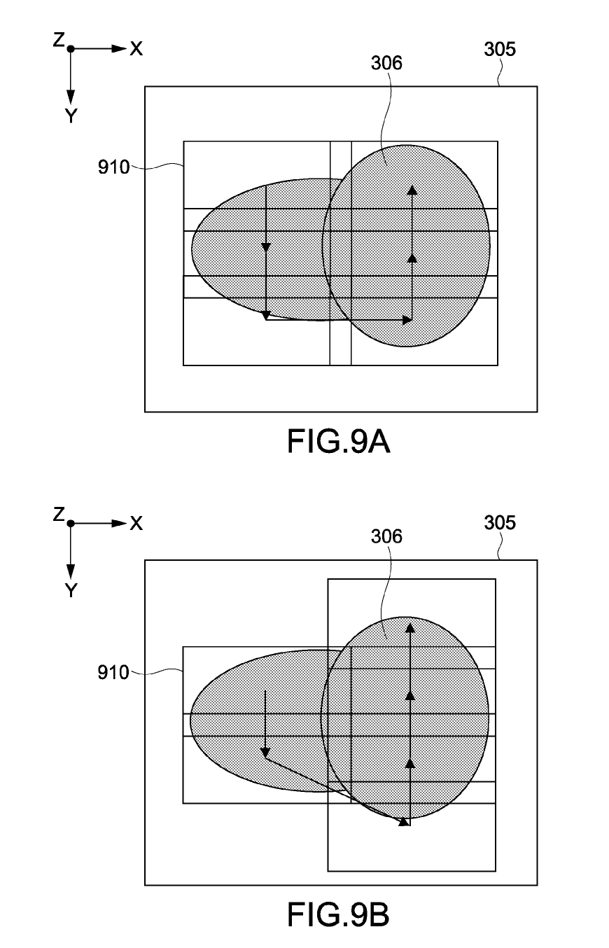

FIGS. 9A and 9B are diagrams for describing shot layouts of a plurality of photography regions 910 described as a comparative example. In the shot layout described as the comparative example, position coordinates of the plurality of photography regions 910 (for example, position coordinates of centers) are arranged in a reticular pattern. In FIG. 9A, the three photography regions 910 are similarly arranged on the first and second rows. In FIG. 9B, the two photography regions 910 are arranged on the first row, and the four photography regions 910 are arranged on the second row based on position coordinates of the two photography regions 910.

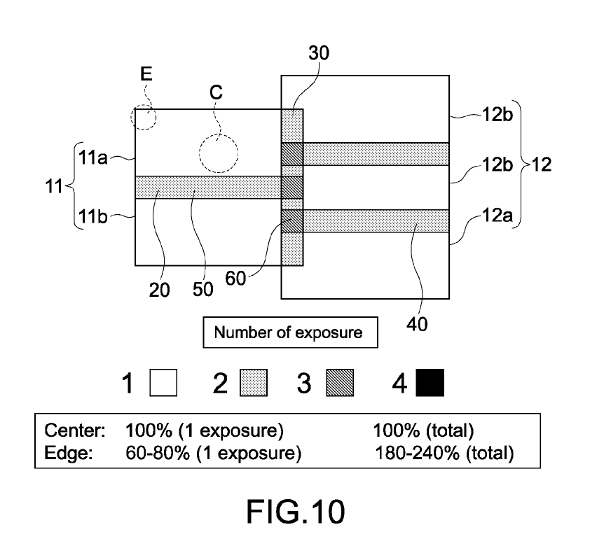

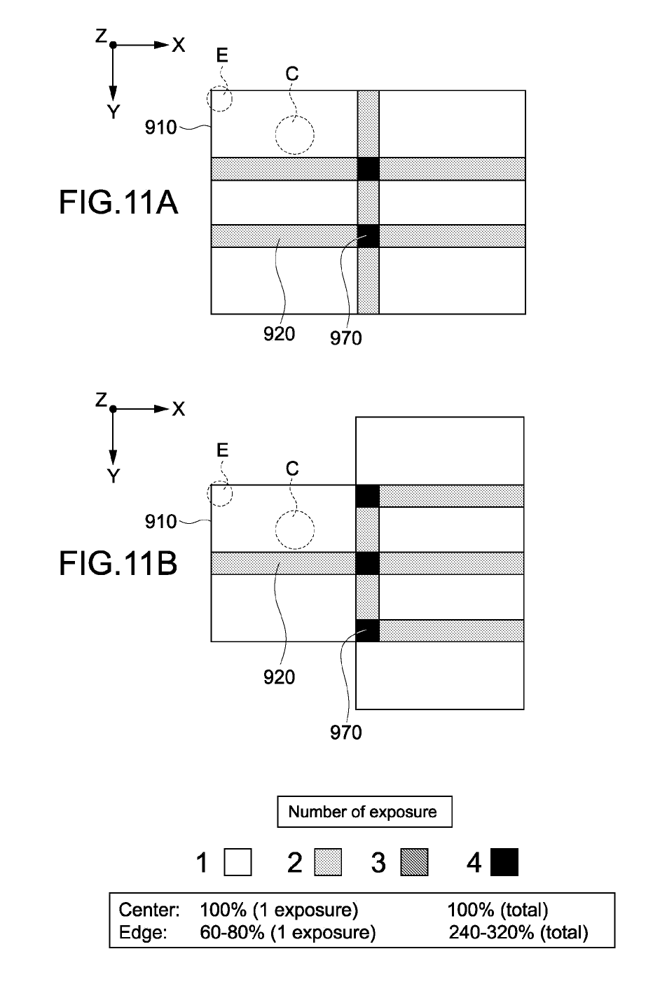

The shot layouts of the first and second photography regions 11 and 12 according to the first embodiment are compared with the shot layout of the photography regions 910 as the comparative example. FIGS. 10 and 11 are diagrams describing the comparison and pattern diagrams illustrating a cumulative light intensity on the overlapping regions on the respective shot layouts.

FIG. 10 is a diagram illustrating a cumulative amount of the excitation light on the first and second overlapping regions 20 and 40 and the overlapping regions 30 in the X axial direction according to the first embodiment (see FIG. 1). In the first embodiment, the excitation light is emitted to the respective photography regions from the illumination lens 303B every time the first and second photography regions 11 and 12 are photographed. The excitation light has an illumination distribution so that a light intensity is 100% at a center portion C of the respective photography regions and is 60% to 80% on a peripheral portion E.

FIG. 10 illustrates the first overlapping region 20 on the first row, the second overlapping regions 40 on the second row, and the overlapping region 30 in the X axial direction between the first row and the second row that are discriminated based on the number of times at which the excitation light is emitted redundantly. In the shot layout according to the first embodiment, first and second photography regions 11 and 12 are arranged so that the first and second overlapping regions 20 and 40 do not overlap with each other. Therefore, only a portion 50 to which the excitation light is emitted two times redundantly and a portion 60 to which the excitation light is emitted three times redundantly are generated as portions to which the excitation light is emitted redundantly. The excitation light with light intensity of 60% to 80% of that on the center portion C is emitted to the peripheral portion E of the respective photography regions, as described above. Therefore, the excitation light with the cumulative amount that is 180% to 240%, namely, 1.8 times to 2.4 times as large as that on the center portion C is emitted to the portion 60 irradiated three times redundantly.

On the other hand, as shown in FIGS. 11A and 11B, in the shot layout of the photography regions 910 as the comparative example, a portion 920 to which the excitation light is emitted two times redundantly and a portion 970 to which the excitation light is emitted four times redundantly are generated as the portions to which the excitation light is emitted redundantly. The excitation light with the cumulative amount that is 240% to 320%, namely, 2.4 times to 3.2 times as large as that on the center portion C is emitted to the portion 970 irradiated four times redundantly.

The PC 100 as the information processing apparatus according to the first embodiment controls the transfer of the XYZ stage 302 of the optical microscope 300. The positions of the first and second photography regions 11 and 12 with respect to the observation region 305 to be imaged by the imaging optical system 304 of the optical microscope 300 are suitably set. As a result, the imaging apparatus 200 can photograph the plurality of first photography regions 11 overlapping with each other in the Y axial direction as the first direction and the plurality of second photography regions 12 overlapping with each other in the Y axial direction. The respective position coordinates of the plurality of first and second photography regions 11 and 12 determined by the PC 100 are set so that the plurality of first and second photography regions 11 and 12 overlap with each other in the X axial direction as the second direction, and the first and second overlapping regions 20 and 40 do not overlap with each other. Therefore, as described with reference to FIGS. 10 to 11B, a region where all the first overlapping region 20, the second overlapping region 40, and the overlapping region 30 in the X direction overlap with each other is not formed, thereby reducing the cumulative amount of the excitation light to be emitted redundantly. This can repress discoloration of the fluorescent pigment included in the sample 306 to be photographed. For this reason, while deterioration in the sample 306 is being suppressed, the plurality of first and second photography regions 11 and 12 can be photographed. As a result, the images of the plurality of first and second photography regions 11 and 12 to be subjected to the stitching process by the PC 100 can be generated.

In the shot layout of the photography regions 910 as the comparative example, the position coordinates of the respective photography regions are determined so that the plurality of photography regions 910 are arranged in a reticular pattern. Therefore, as shown in FIGS. 9A and 9B, the six photography regions 910 are necessary for arranging the plurality of photography regions 910 to cover the entire sample 306.

On the other hand, as shown in FIG. 8A, in the shot layout according to the first embodiment, the position coordinate of the standard photography region 12a arranged on the second row can be appropriately set based on the detected position coordinate of the edge portion 315 of the sample 306. As a result, as shown in FIG. 8B, in the first embodiment, the five photography regions including the two first photography regions 11 arranged on the first row and the three second photography regions 12 (including the standard photography region) arranged on the second row can cover the entire sample 306. As a result, it is possible to reduce the number of the photography regions to be photographed, thereby reducing the number of emission times of the excitation light. For this reason, the plurality of first and second photography regions 11 and 12 can be photographed in a short time.

In FIGS. 8A to 9B, arrows indicate the arrangement order of the respective photography regions. The sizes of the arrows are substantially equal to the transfer distance of the XYZ stage 302. As shown in FIGS. 8A to 9B, a great difference in the transfer distance of the XYZ stage is not generated between the shot layout according to the first embodiment and the shot layout as the comparative example. Therefore, setting of the shot layout according to the first embodiment does not make the transfer time of the XYZ stage long, and the plurality of first and second photography regions 11 and 12 can be photographed in a short time.

### Second Embodiment

The information processing apparatus according to a second embodiment will be described. In the following description, description about various apparatuses and the operations thereof similar to those used in the imaging system 400 described in the first embodiment are omitted or simplified.

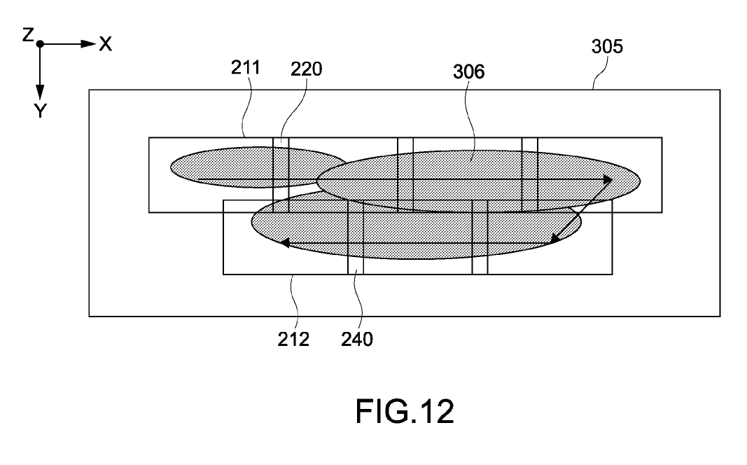

FIG. 12 is a pattern diagram for describing the shot layout of the photography regions determined by the control of the PC as the information processing apparatus according to the second embodiment.

As shown in FIG. 12, in the second embodiment, a plurality of first photography regions 211 and a plurality of second photography regions 212 are arranged along an X axial direction set as the horizontal direction. The plurality of first photography regions 211 and the plurality of second photography regions 212 are arranged so as to overlap with each other in a Y axial direction determined as the vertical direction.

The first photography regions 211 are arranged so as to have first overlapping regions 220 where the respective adjacent regions 211 overlap with each other in the X axial direction. The second photography regions 212 are arranged so as to have second overlapping regions 240 where the respective adjacent regions 212 overlap with each other in the X axial direction. The plurality of first and second photography regions 211 and 212 are arranged so that the first and second overlapping regions 220 and 240 do not overlap with each other.

In the above first embodiment, the Y axial direction that is the vertical direction and the X axial direction that is the horizontal direction are set as the first and the second directions. However, like the second embodiment, the X axial direction as the horizontal direction and the Y axial direction as the vertical direction may be set as the first and the second directions. Even when the first and the second directions are set in such a manner, the effect similar to that in the first embodiment can be obtained.

### Third Embodiment

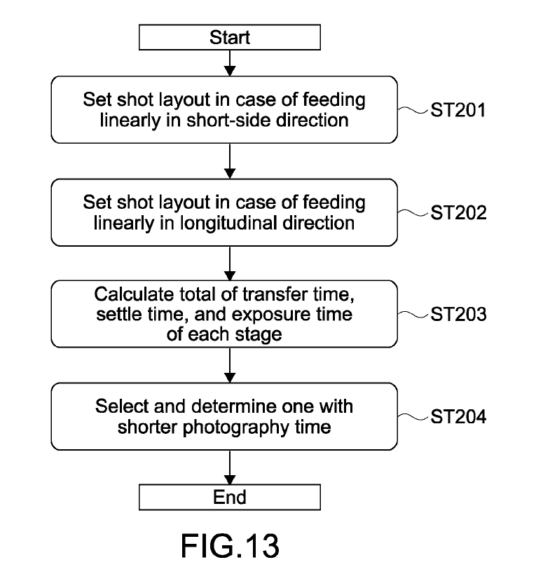

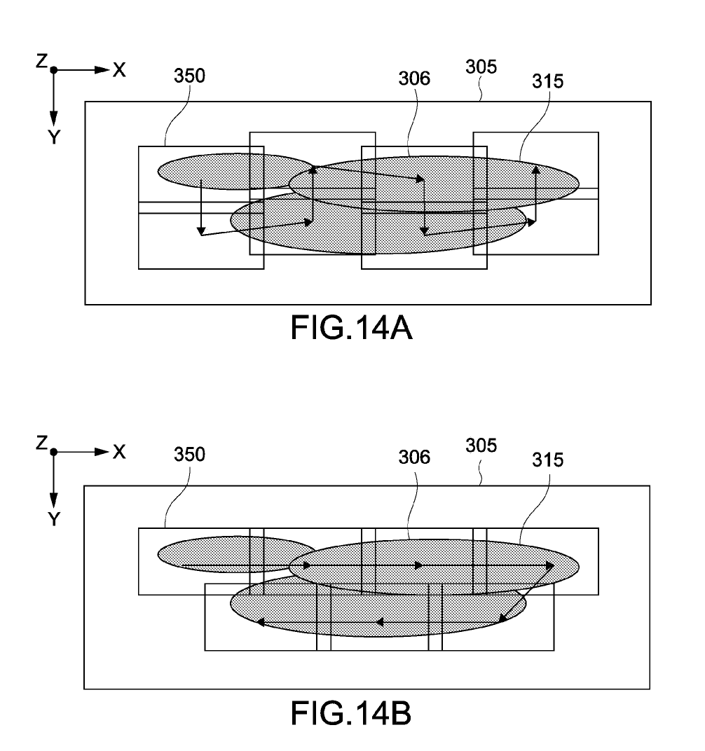

FIG. 13 is a flowchart illustrating an outline of a method of setting the shot layout of the photography regions in the information processing apparatus according to a third embodiment. FIGS. 14A and 14B are pattern diagrams for describing respective steps in the flowchart shown in FIG. 13.

In the information processing apparatus according to the third embodiment, any one of a first direction setting pattern and a second direction setting pattern described below can be selected. The first direction setting pattern is a pattern in which the first direction is set as the vertical direction and the second direction is set as the horizontal direction as described in the first embodiment. The second direction setting pattern is a pattern in which the first direction is set as the horizontal direction and the second direction is set as the vertical direction as described in the second embodiment.

The shot layouts of the photography regions in the respective direction setting patterns are as described in the first and second embodiments. Therefore, the description will be made mainly on how to select one of the direction setting patterns using the information processing apparatus.

In the third embodiment, the Y axial direction is a short-side direction of photography regions 350 and the X axial direction is a longitudinal direction of the photography regions 350. Therefore, in the first direction setting pattern, the photography regions 350 are fed linearly along the short-side direction of the photography regions 350. On the other hand, in the second direction setting pattern, the photography regions 350 are fed linearly along the longitudinal direction of the photography regions 350.

As shown in FIG. 14A, the shot layout is set in the case where the first direction setting pattern is selected and the photography regions 350 are fed linearly in the short-side direction (step 201).

For example, the CPU of the PC generates a thumbnail image showing the entire observation region 305, and may set the shot layout of the photography regions 350 using this thumbnail image. At this time, the thumbnail image may be displayed on the display section (see FIG. 4) of the information processing apparatus for a user to appropriately regulate the shot layout. Alternatively, the information processing apparatus detects the position coordinate of the edge portion 315 of the sample 306, and sets the respective position coordinates of the photography regions 350 to be arranged based on the position coordinate of the edge portion 315. Information about the respective position coordinates of the photography regions 350 may be stored in the storage section of the PC.

As shown in FIG. 14B, the shot layout in the case where the second direction setting pattern is selected and the photography regions 350 are fed linearly in the longitudinal direction is set (step 202).

A total time is calculated by adding the transfer time of the XYZ stage, a settle time for stop of the XYZ stage on a predetermined position, and an exposure time for emitting the excitation light to the photography regions 350 in the respective shot layouts set at steps 201 and 202 (step 203). That is to say, a period of time for photographing the plurality of the photography regions 350 arranged to cover the entire sample 306 is calculated for each of the shot layouts at step 203.

The total of the photography times on the shot layout in the first direction setting pattern is compared with the total of the photography times in the shot layout in the second direction setting pattern. The direction setting pattern with the shot layout in which the total of the photography times is shorter is selected (step 204).

For example, the number of the photography regions 350 necessary for covering the entire sample 306 is occasionally different between the first and the second direction setting patterns depending on the entire shape of the sample 306 to be photographed as shown in FIGS. 14A and 14B. For example, in the description of the third embodiment, the number of the photography regions 350 to be arranged in the shot layout in the second direction setting pattern shown in FIG. 14B is smaller than that in the shot layout in the first direction setting pattern shown in FIG. 14A. The smaller number of the photography regions 350 for covering the entire sample 306 is advantageous to the shortening of the photography time of the plurality of photography regions 350.

On the other hand, when the case where the photography regions 350 are fed linearly along the short-side direction is compared with the case where they are fed linearly along the longitudinal direction, the transfer time of the XYZ stage is shorter in the case of feeding along the short-side direction. Therefore, the first direction setting pattern in which the photography regions 350 are fed linearly along the short-side direction is more advantageous to the shortening of the photography time.

In the third embodiment, the photography times of the plurality of photography regions 350 in the respective shot layouts in the first and the second direction setting patterns are compared. For this reason, the suitable direction setting pattern can be selected. As a result, the plurality of photography regions 350 can be photographed in a short processing time.

The information processing apparatus according to each of the above-mentioned embodiments is used in a system or the like in which images of biological cells, tissues, and organs obtained by the optical microscope in medical and pathological fields are digitalized and doctors and pathologists check the tissues or the like and diagnose patients based on the digital images. However, the information processing apparatus are not limited to these fields, and can be applied to other fields.

### Fourth Embodiment

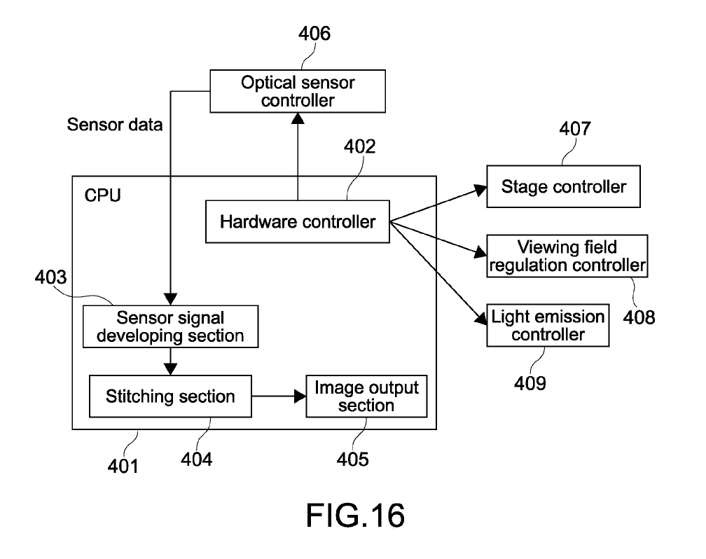

The PC as the information processing apparatus according to a fourth embodiment will be described. The PC according to the fourth embodiment is used in the imaging system including the optical microscope and the imaging apparatus similarly to the above embodiments (see FIGS. 1 and 2). FIG. 16 is a diagram schematically illustrating a functional block of the CPU 401 of the PC according to the fourth embodiment.

As shown in FIG. 16, the CPU 401 includes a hardware controller 402, a sensor signal developing section 403, a stitching section 404, and an image output section 405. These blocks are constituted by a program stored in the ROM of the PC or dedicated hardware.

The hardware controller 402 outputs a control signal for controlling various hardware of the imaging apparatus and the optical microscope. As shown in FIG. 16, a control signal is output from the hardware controller 402 to an optical sensor controller 406, a stage controller 407, a viewing field regulation controller 408, and a light emission controller 409.

The optical sensor controller 406 is a block for controlling an optical sensor of a CMOS or a CCD, and controls photography timing of the imaging apparatus and transfers a signal generated by the optical sensor to the CPU 401. The stage controller 407 controls the XYZ stage and a lens barrel of the optical microscope, or an actuator for moving the sample to be a subject. The viewing field regulation controller 408 can control the sizes of the photography regions to be photographed by the imaging apparatus in the two orthogonal axial directions, and controls a change and a transfer of a field diaphragm of the optical microscope. The light emission controller 409 performs control related to the exposure, for example, the exposure time for photographing by the imaging apparatus, and intensity of the excitation light to be emitted to the sample.

The respective blocks of the optical sensor controller 406, the stage controller 407, the viewing field regulation controller 408, and the light emission controller 409 may be included in the camera controller of the imaging apparatus. Alternatively, dedicated control boxes having the functions of the respective blocks may be provided to the imaging apparatus or the optical microscope.

The sensor signal developing section 403 of the CPU 401 executes a developing process so that a signal transmitted from the optical sensor is received and can be visualized as an image or a video image. The sensor signal developing section 403 generates image data of photography regions photographed by the imaging apparatus.

The stitching section 404 executes the stitching process on the image data of the photography regions. For example, image data of two photography regions having overlapping regions is input into the stitching section. The stitching section detects highly correlated regions in the overlapping region and stitches two image data based on the highly correlated regions. As a result, synthesized single image data is generated.

The image output section 405 converts the image data input via the stitching section 404 into a file format for facilitating a process on the PC, such as Joint Photographic Experts Group (JPEG) or Tagged Image File Format (Tiff), and outputs the image data as the file.

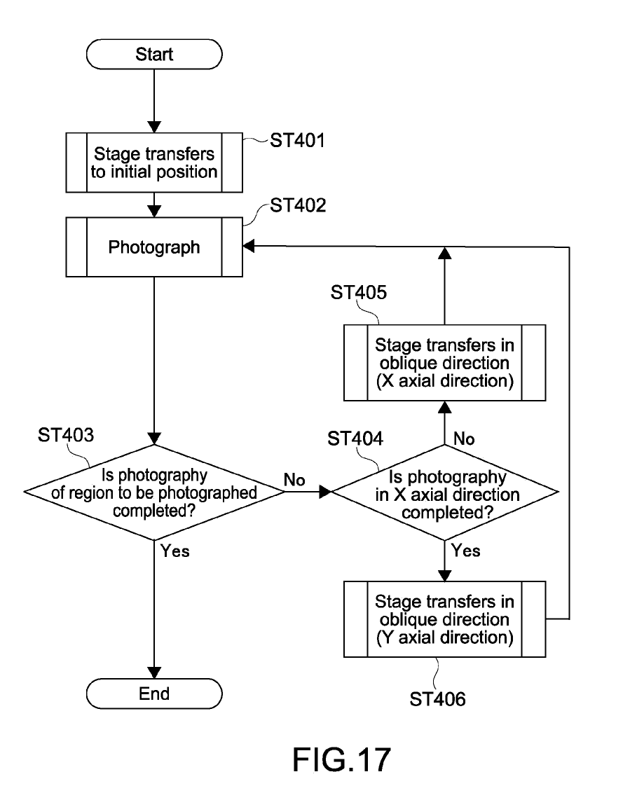

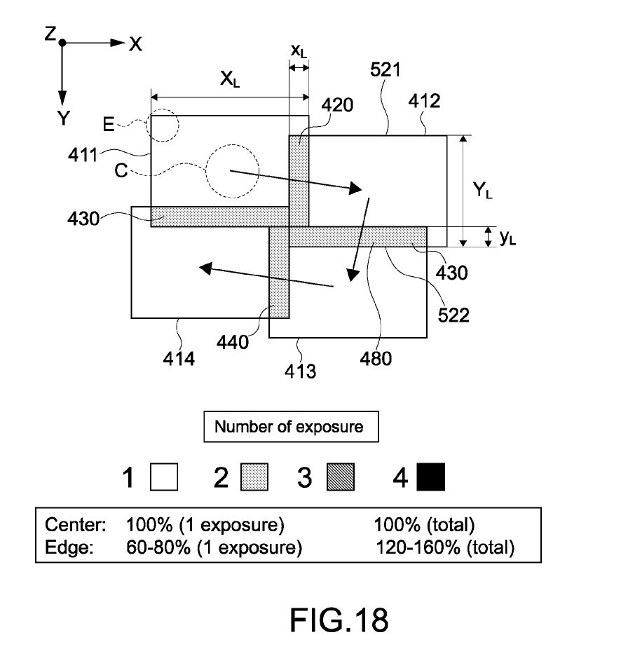

A method of setting shot layout using the PC as the information processing apparatus according to the fourth embodiment will be described. FIG. 17 is a flowchart illustrating an outline of the method of setting the shot layout. FIG. 18 is a pattern diagram for describing respective steps of the flowchart shown in FIG. 17.

Also in the fourth embodiment, the position of the sample as a subject to be photographed (not shown) is detected similarly to the above embodiments. The position of the sample is detected based on the entire image or the thumbnail image of the sample, as described above. Alternatively, a contour of the sample and a position of a nucleus in the sample may be detected based on the received light signal output from the optical sensor controller 406 shown in FIG. 16 to the sensor signal developing section 403 of the CPU 401.

The photography regions in the fourth embodiment has predetermined sizes in the X axial direction and the Y axial direction shown in FIG. 18 that are the first direction and the second direction as the two orthogonal axial directions. The size of the photography regions in the X axial direction is X_{L}, and the size in the Y axial direction is Y_{L}.

The position coordinate of a first photography region 411 shown in FIG. 18 is determined based on the shape of the sample to be photographed, and the XYZ stage of the optical microscope is transferred to an initial position (step 401). The excitation light or the like is emitted to the first photography region 411, and the first photography region 411 is photographed (step 402).

A determination is made whether the photography of all the photography regions to be photographed is completed, namely, whether the entire sample is photographed (step 403). For example, it is sufficient that the determination be made whether the photography of the entire sample is completed based on the detected shape and position of the sample.

When the determination is made that the photography of the regions to be photographed is not completed, (No at step 403), a determination is made whether the photography in the X axial direction as the first direction is completed (step 404). That is to say, the determination is made whether the sample to be photographed is positioned on a region extending in the X axial direction as viewed from the first photography region 411.

When the determination is made that the photography in the X axial direction is not completed (No at step 404), the position coordinate of a second photography region 412 shown in FIG. 18 is determined based on the position coordinate of the first photography region 411, and the XYZ stage is transferred in an oblique direction (step 405). The second photography region 412 is a photography region arranged next to the first photography region 411 in the X axial direction. The transfer in the oblique direction at step 405 means transfer mainly in the X axial direction and transfer also in the Y axial direction as the second direction.

In the fourth embodiment, as shown in FIG. 18, the XYZ stage transfers by X_{L}-x_{L} in the X axial direction, and transfers by the size Y_{L} in the Y axial direction as the second direction. Therefore, the first and second photography regions 411 and 412 overlap with each other on the first overlapping region 420 whose size is x_{L} in the X axial direction. Both the position coordinates in the Y axial direction are different from each other by the size y_{L}.

When the XYZ stage transfers to the above-mentioned predetermined position, the second photography region 412 is photographed (step 402), and a determination is made again whether the photography of the region to be photographed is completed and the photography in the X axial direction is completed (steps 403 and 404).

When the determination is made at step 404 that the photography in the X axial direction is completed (Yes at step 404), the position coordinate of a third photography region 413 shown in FIG. 18 is determined based on the position coordinate of the second photography region 412, and the XYZ stage is transfers in the oblique direction (step 406). The third photography region 413 is a photography region arranged next to the second photography region 412 in the Y axial direction. The transfer in the oblique direction at step 406 means the transfer mainly in the Y axial direction and transfer also in the X axial direction.

In the fourth embodiment, the XYZ stage transfers by Y_{L}-y_{L} in the Y axial direction at step 406, and transfers by the size x_{L} in the X axial direction. Therefore, the second and third photography regions 412 and 413 overlap with each other on a third overlapping region 430 whose size is y_{L} in the Y axial direction. Further, both the position coordinates in the X axial direction are different from each other by the size x_{L}. The second photography region 412 is misaligned by the size y_{L} with respect to the first photography region 411 in the Y axial direction, and the second and third photography regions 412 and 413 overlap with each other on the misaligned portion. Therefore as shown in FIG. 18, the first photography region 411 does not overlap by using the third photography region 413 as a reference.

The sequence returns to step 402 so that the third photography region 413 is photographed, and the sequence proceeds to step 404 again. The determination is made at step 404 that the photography in the X axial direction is uncompleted based on the third photography region 413. The position coordinate of a fourth photography region 414 shown in FIG. 18 is determined, the XYZ stage transfers in the oblique direction (step 405). As shown in FIG. 18, the XYZ stage transfers by X_{L}-x_{L} in the X axial direction and transfers by the size y_{L} in the Y axial direction from the position of the third photography region 413. A direction of the transfer in the X axial direction and the Y axial direction is opposite to a direction of the transfer from the position of the first photography region 411 to the position of the second photography region 412 in the X axial direction and the Y axial direction.

As a result, the third and fourth photography regions 413 and 414 overlap with each other on a second overlapping region 440 whose size is x_{L}, in the X axial direction. Further, both the position coordinates in the Y axial direction are different from each other by the size y_{L}. Also, the first and fourth photography regions 411 and 414 overlap with each other on a third overlapping region 430 whose size is y_{L} in the Y axial direction. That is to say, the third overlapping region 430 is a region where the third and fourth photography regions 413 and 414 overlap with the first and second photography regions 411 and 412 in the Y axial direction.

The third photography region 413 is misaligned by the size x_{L} with respect to the second photography region 412 in the X axial direction, and the third and fourth photography regions 413 and 414 overlap with each other on the misaligned portion. Therefore, as shown in FIG. 18, the second photography region 412 and the fourth photography region 414 do not overlap with each other. That is to say, as shown in FIG. 18, the respective position coordinates of the first to fourth photography regions 411 to 414 are set so that the first, second, and third overlapping regions 420, 440, and 430 are prevented from overlapping with each other.

When the determination is made at step 403 that the photography of the region to be photographed is completed (Yes at step 403), the photography of the sample is terminated.

FIG. 18 illustrates the cumulative light intensity on the first, second, and third overlapping regions 420, 440 and 430. In the shot layout according to the fourth embodiment, as described above, the respective position coordinates of the first to fourth photography regions 411 to 414 are set so that the first, second, and third overlapping regions 420, 440, and 430 are prevented from overlapping with each other. Therefore, only a portion 480 to which the excitation light is emitted twice redundantly is generated as a portion to which the excitation light is emitted redundantly. The excitation light or the like whose light intensity is 60 to 80% of the light emitted to the center portion C is emitted to the peripheral portion E of the respective regions as described above. Therefore, the portion 480 to which the excitation light is emitted twice redundantly is irradiated with the light of the cumulative amount of 120% to 160%, namely, 1.2 times to 1.6 times as large as that of the light emitted to the center portion C.

In the PC as the information processing apparatus according to the fourth embodiment, the respective position coordinates of the first and second photography regions 411 and 412 overlapping with each other on the first overlapping region 420 and of the third and fourth photography regions 413 and 414 overlapping with each other on the second overlapping region 440 are set. The first and second photography regions 411 and 412 and the third and fourth photography regions 413 and 414 overlap with each other on the third overlapping region 430. The respective position coordinates of the first and second photography regions 411 and 412 in the Y axial direction are made to be different from each other by the size y_{L}, and further the respective position coordinates of the third and fourth photography regions 413 and 414 in the Y axial direction are made to be different from each other by the size y_{L}, as described above. As a result, the respective position coordinates can be set so that the first, second, and third overlapping regions 420, 440, and 430 are prevented from overlapping with each other. As a result, the cumulative amount of the excitation light to be emitted to the respective overlapping regions redundantly can be reduced, and the plurality of photography regions can be photographed while deterioration in the sample to be photographed is being suppressed.

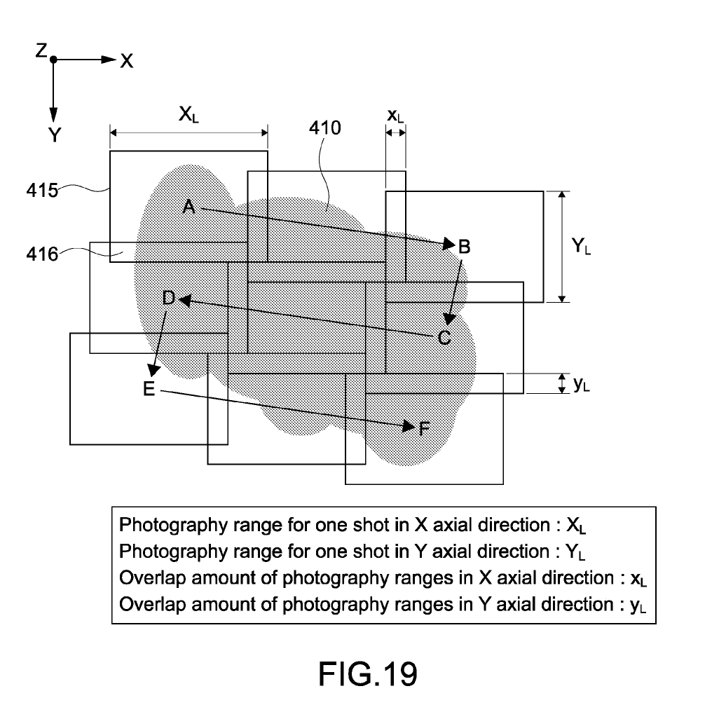

FIG. 18 illustrates the four photography regions including the first to fourth photography regions 411 to 414, the number of photography regions to be photographed is not limited to this. For example, as shown in FIG. 19, a sample 410 whose size disables the photography on four photography regions is photographed. Even in this case, it is sufficient that the process including the respective steps in the flowchart shown in FIG. 17 be executed. As a result, the XYZ stage transfers from a position A to a position F shown in FIG. 19, and respective photography regions 415 are photographed. Since overlapping regions 416 where the plurality of photography regions 415 overlaps with each other do not overlap with each other, the cumulative light intensity on the respective overlapping regions 416 can be reduced. As a result, while the deterioration in the sample 410 is being suppressed, the plurality of photography regions 415 enables the photography of the entire sample 410.

### Fifth Embodiment

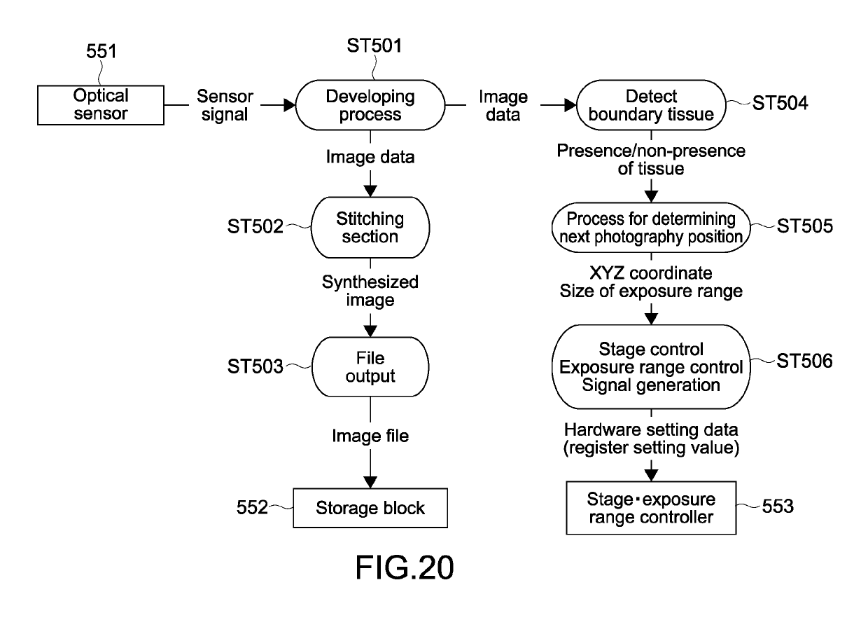

The PC as the information processing apparatus according to a fifth embodiment will be described. FIG. 20 is a data flow diagram illustrating a flow of various data in the photographing system including the PC according to the fifth embodiment.

A signal generated by the optical sensor 551 of the imaging apparatus is output to the sensor signal developing section of the CPU, and a developing process such as a calculation of a brightness signal and a calculation of a color signal is executed (step 501). As a result, image data of the photography region photographed by the imaging apparatus is generated. The image data is input into the stitching section of the CPU, and a plurality of pieces of image data are subjected to the stitching process, so that synthesized single image data is generated (step 502). The synthesized image data is input into the image output section of the CPU. At this time, for example, the synthesized image data is converted into a file format specified by a user to be output as an image file (step 503). The output image file is stored in a storage block 552 such as an HDD or an Solid State Drive (SSD) of the CPU. The data flow from steps 501 to 503 is also executed similarly to the above-mentioned embodiments.

As shown in FIG. 20, in the fifth embodiment, a determination is made whether a cell as a subject is positioned on a boundary of the photographed photography region based on the image data generated at step 501 (step 504). A process of determining a next photography position is executed by the CPU based on data about presence/non-presence of the cell generated at step 504 (step 505). In the next photography position determining process, the position coordinate of a photography region to be photographed next and an exposure range are determined based on the presence/non-presence of the cell on the boundary, a predetermined photography order, and an overlap amount of the photography regions. The exposure range means sizes of photography regions to be photographed in the X axial direction and the Y axial direction.

The hardware controller of the CPU outputs a control signal necessary for hardware control as a register setting value based on the data about the position coordinate of the next photography region and the data about the size of the photography region generated in the next photography position determining process at step 505 (step 506). The register setting value output by the hardware controller is input into a stage exposure range controller 553 provided to the imaging apparatus or the optical microscope, and the transfer of the XYZ stage of the optical microscope is controlled. Further, the field diaphragm of the optical microscope is changed or is shifted, so that the size of the exposure range, namely, the size of the photography region is controlled. That is to say, the CPU of the PC according to the fifth embodiment functions as a changing means capable of changing the respective sizes of the photography regions in the two axial directions and a determining means for determining whether a cell is positioned on the boundaries.

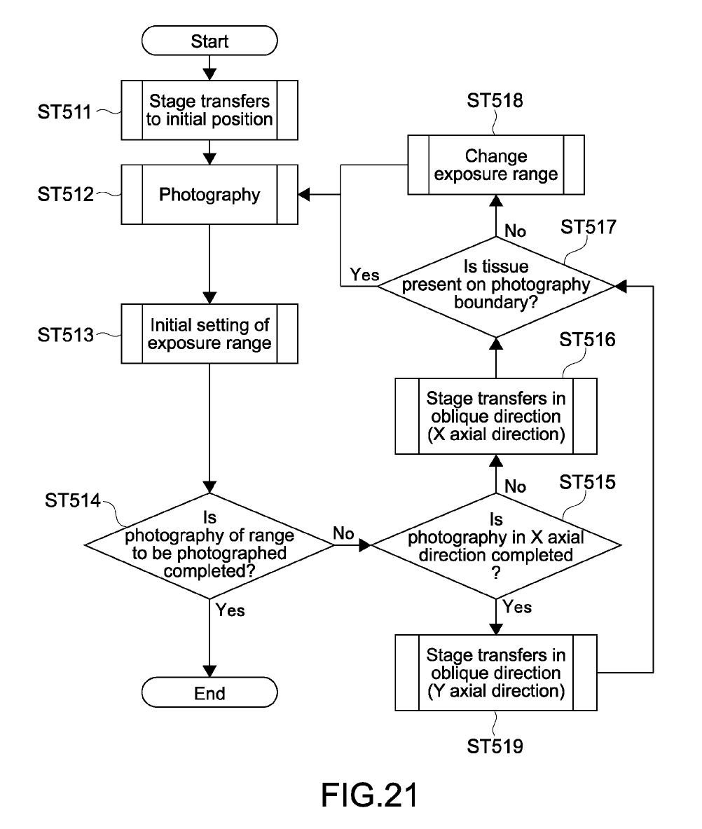

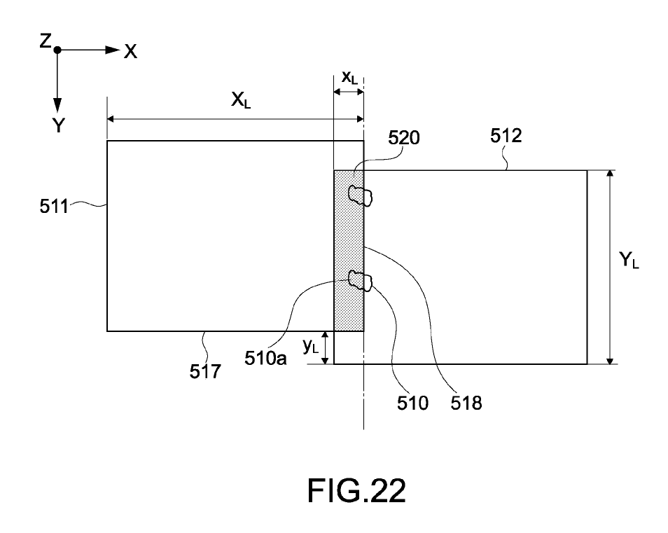

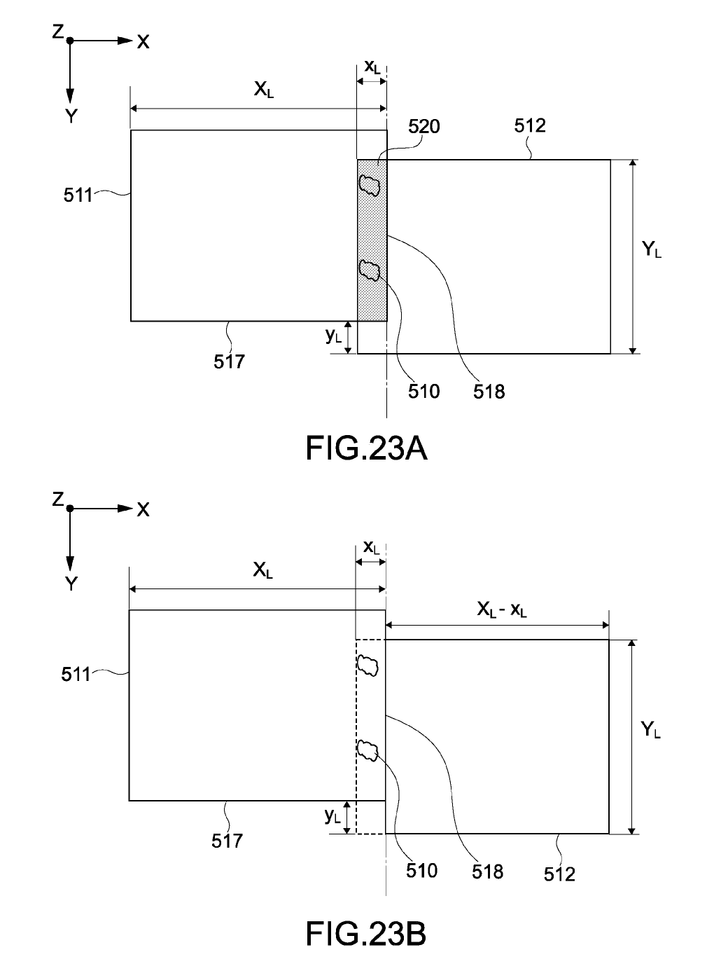

The method of setting the shot layout according to the fifth embodiment will be described mainly as to the operation of the PC based on the data flow from steps 504 to 506 shown in FIG. 20. FIG. 21 is a flowchart illustrating an outline of the shot layout setting method. FIG. 22 to FIG. 23B are pattern diagrams for describing respective steps in the flowchart shown in FIG. 21.

A position coordinate of a first photography region 511 shown in FIG. 22 is determined based on the shape of the sample to be photographed, and the XYZ stage of the optical microscope is transferred to the initial position (step 511). The excitation light or the like is emitted to the first photography region 511, and the first photography region 511 is photographed (step 512).

The sizes of the exposure range, namely, the photography regions to be photographed in the X axial direction and the Y axial direction are set to initial setting values (step 513). In the fifth embodiment, the initial setting values of the sizes of the photography regions are X_{L} in the X axial direction, and Y_{L} in the Y axial direction. As described above, the sizes of the photography regions are controlled by, for example, changing the field diaphragm of the optical microscope by means of the stage exposure range controller 553 that have received the register setting value from the CPU. As shown in FIG. 22, the first photography region 511 is photographed with the size of the initial setting value.

Similarly to the fourth embodiment, the sequence proceeds to steps 514 to 516, and the position coordinate of a second photography region 512 overlapping with the first photography region 511 on a first overlapping region 520 whose size in the X axial direction is x_{L} is set.

In the fifth embodiment, after the second photography region 512 is arranged, a determination is made whether cells 510 as subjects are positioned on the photography boundary (step 517). “The photography boundary” means an edge portion 518 of the first overlapping region 520 on an edge portion 517 of the photographed first photography region 511. As shown in FIG. 22, when the cells 510 are positioned on the edge portion 518 of the first overlapping region 520 (Yes at step 517), the size of the second photography region 512 is not changed and the second photography region 512 is photographed at step 512.

The first and second photography regions 511 and 512 are photographed so as to have the first overlapping region 520. As a result, when the photographed first and second photography regions 511 and 512 are subjected to the stitching process, the cells 510 are suitably expressed. Every time the first and second photography regions 511 and 512 are photographed, the excitation light or the like is emitted to portions 510a, which are positioned on the first overlapping region 520, of the cells 510. Therefore, the excitation light is emitted to the portions 510a twice.

As shown in FIG. 23A, when the cells 510 are not positioned on the edge portion 518 of the first overlapping region 520 on the edge portion 517 of the first photography region 511 (No at step 517), the exposure range is changed, and the size of the second photography region 512 is changed (step 518).

As shown in FIG. 23B, the size of the second photography region 512 in the X axial direction is set to be smaller by the size x_{L} of the first overlapping region 520 in the X axial direction. Therefore, the size of the second photography region 512 in the X axial direction becomes X_{L}-x_{L}. The sequence returns to step 512, and the second photography region 512 whose size has been changed is photographed. That is to say, the first and second photography regions 511 and 512 are photographed so as not to have the first overlapping region 520. Even when the first and second photography regions 511 and 512 are photographed so as not to have the first overlapping region 520 and both the generated images are connected without overlap, the cells 510 are suitably expressed as shown in FIG. 23B.

The size of the second photography region 512 is appropriately set based on whether the cells 510 are positioned on the edge portion 517 of the first overlapping region 520, and presence/non-presence of the first overlapping region 520 is appropriately set so that the region (the first overlapping region 520) to which the excitation light is emitted redundantly can be reduced. When the first photography region 511 is photographed, the excitation light is emitted to the cells 510 shown in FIGS. 23A and 23B. However, when the second photography region is photographed, the excitation light is not emitted to the cells 510. Therefore, since only the excitation light for one time is emitted to the cells 510, deterioration in the cells 510 due to discoloration or the like can be sufficiently suppressed.

When the second photography region 512 is photographed, the sizes of a next photography region in the X axial direction and the Y axial direction are returned to initial values at step 513 in FIG. 21. The sequence proceeds to step 515, and when the determination is made that the photography in the X axial direction is completed (step Yes at step 515), the XYZ stage is transferred in the oblique direction mainly in the Y axial direction (step 519). Also at this time, the presence/non-presence of cells on the photography boundary is determined at step 517.

The process in this case is described with reference to the second and third photography regions 412 and 413 shown in FIG. 18. That is to say, when cells are positioned on an edge portion 521 of the second photography region 412 and an edge portion 522 of the third overlapping region 430, the third photography region 413 is directly photographed without changing the size. On the other hand, when cells are not positioned on the edge portion 522 of the third overlapping region 430, the size of the third photography region 413 in the Y axial direction is set to be smaller by the size y_{L} of the third overlapping region 430 in the Y axial direction. As a result, the size of the third photography region 413 in the Y axial direction becomes Y_{L}-y_{L}, and the second and third photography regions 412 and 413 are photographed so as not to have the third overlapping region 430. As a result, only the excitation light for one time is emitted to the cells positioned on the third overlapping region 430.

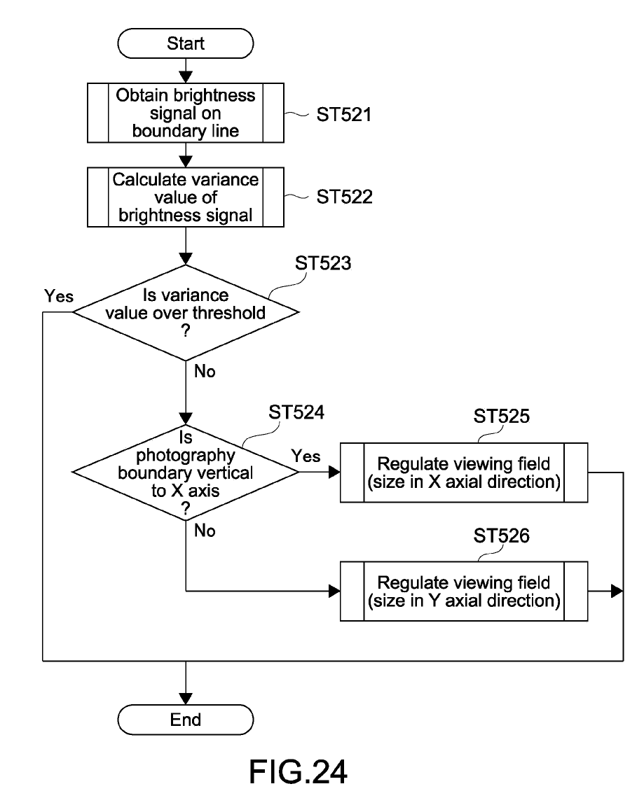

FIG. 24 is a flowchart illustrating a flow of the process for determining whether cells are positioned on the boundary of photography regions and changing the sizes of photography regions.

Information about a brightness signal on a boundary line is obtained (step 521). The information about the brightness signal on the boundary line means information about a brightness signal sequence on the boundary between a photographed photography region and a photography region to be photographed next, namely, the information obtained from image data about the photographed photography regions. FIGS. 22 to 23B are described as example. The information about a brightness signal sequence of respective pixels on a portion corresponding to the edge portion 518 of the first overlapping region 520 is obtained from the image data of the first photography region 511 photographed at step 521.

A variance value of the brightness signal sequence on the boundary line is calculated based on the brightness signal information obtained at step 521 (step 522). A determination is made whether the calculated variance value exceeds a threshold set in advance (step 523).

The variance value represents how much the brightness signal of the respective pixels scatter with respect to an average value of the brightness signal sequence on the boundary line. Therefore, when cells are positioned on the boundary line, the variance value becomes large, and when no cell is positioned, the variance value becomes small. As a result, when the calculated variance value is smaller than a threshold, a determination can be made that no cell is positioned on the boundary line, and when the variance value is larger than the threshold, the determination can be made that the cells are positioned. It is sufficient that the threshold be set by photographing a photography region where a cell is present on the boundary line and a photography region where no cell is present in advance and calculating respective variance values using their image data as a sample.

A parameter for determining the presence/non-presence of a cell is not limited to the above-mentioned variance value, and a standard deviate and an average value of the brightness signal sequence may be used. A level of a so-called dynamic range that is a difference between a maximum brightness value and a minimum brightness vale in the brightness signal sequence, or an amount of a high-frequency component on the boundary line may be used as the parameter. A determination may be made whether a cell is positioned on the boundary line based on information about a position of the cell calculated before photography.

When the determination is made that the variance value of the brightness signal sequence on the boundary line exceeds the threshold at step 523 shown in FIG. 24 (Yes at step 523), the size of the photography region is not changed and the process is terminated.

When the determination is made that the variance value of the brightness signal sequence on the boundary line does not exceed the threshold (No at step 523), a determination is made whether the photography boundary is perpendicular to the X axis (step 524). That the photography boundary is perpendicular to the X axis means that the above-mentioned boundary line is perpendicular to the X axis, and is in a state shown in FIGS. 22 to 23B, for example. In this case (Yes at step 524), as shown in FIG. 23B, the size of the second photography region 512 in the X axial direction is set to be smaller by the size x_{L} of the first overlapping region 520 in the X axial direction (step 525).

On the other hand, that the photography boundary is not perpendicular to the X axis means that the above-mentioned boundary line is not perpendicular to X axis, and is in a state that the third photography region 413 shown in FIG. 18 is photographed. In this case (No at step 524), the size of the third photography region 413 in the Y axial direction shown in FIG. 18 is set to be smaller by the size y_{L} of the third overlapping region 430 in the Y axial direction (step 525).

At step 525 or 526, when the change and the regulation of the size of the photography regions are completed, the process is terminated.

The process of determining whether a cell is positioned on the boundary line and changing the sizes of the photography regions described in the fifth embodiment can be applied also to the above-mentioned other embodiments.

### Sixth Embodiment

The PC as the information processing apparatus according to a sixth embodiment will be described. The PC according to the sixth embodiment is also used in the imaging system including the optical microscope and the imaging apparatus similarly to the above-mentioned embodiments. In the imaging system according to the sixth embodiment, one sample is photographed at different focal points in the Z axial direction as the focus direction of the optical microscope (see FIG. 1), and images of the sample at respective focal points are generated. This is referred to as a so-called Z-stack. Since a shape of a tissue or a cell of the sample occasionally varies in the thickness direction, this function copes with such a case.

When one sample is photographed at different focal points, the images are generated at the respective focal points. At this every time of the photography, a plurality of photography regions to be subjected to the stitching process are photographed. As a result, since the cumulative amount of the excitation light on the respective overlapping regions further increases, deterioration in the sample due to discoloration advances. However, since the cumulative light intensity on the respective overlapping regions can be reduced in the above-mentioned embodiments, these embodiments are effective for the case where a sample is photographed at each different focal point.

In the PC process according to the sixth embodiment, the deterioration in a sample due to discoloration can be further suppressed at the time when one sample is photographed a plurality of times at various focal points by the Z-stack function.

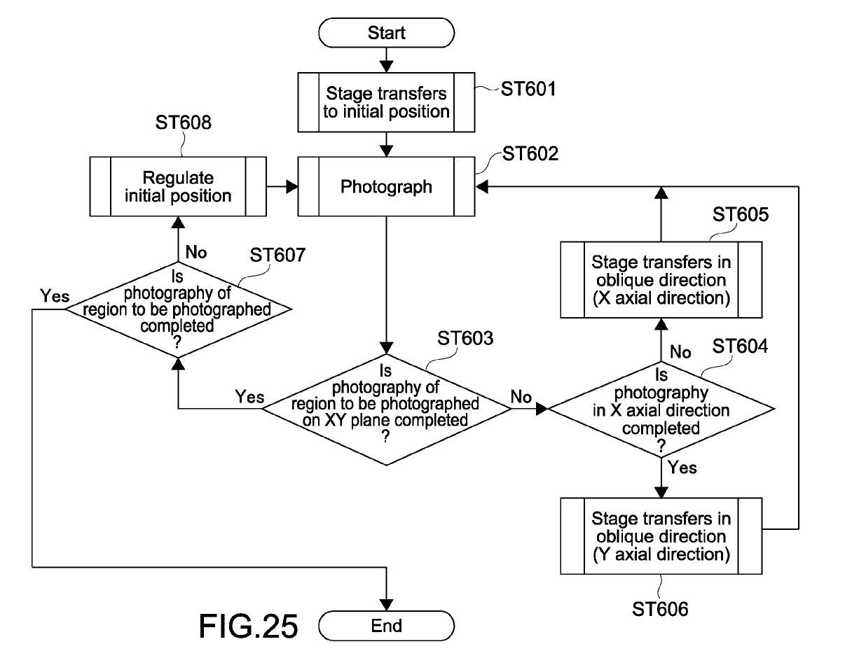

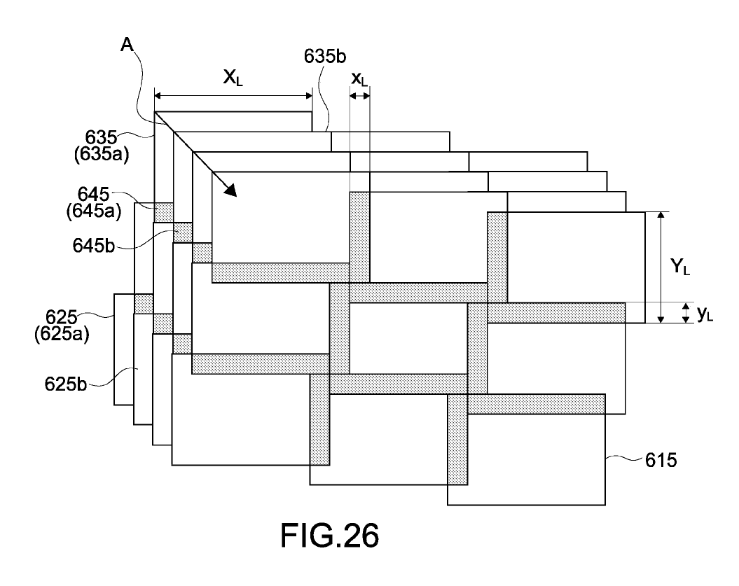

FIG. 25 is a flowchart illustrating an outline of the method of setting shot layouts by means of the PC according to the sixth embodiment. FIG. 26 is a pattern diagram for describing respective steps in the flowchart shown in FIG. 25.

Steps 601 to 606 shown in FIG. 25 are similar to steps 401 to 406 in the flowchart shown in FIG. 17 described in the fourth embodiment. The photography of the sample at one focal point is completed by repeating the processes at steps 601 to 606. Hereinafter, as shown in FIG. 26, a group of a plurality of photography regions 615 to be photographed at one focal point is described as a layer 625.

When a determination is made at step 603 that the photography of regions to be photographed on an XY plane at one focal point is completed and the photography of one layer 625a shown in FIG. 26 is completed (Yes at step 603), a determination is made whether photography of another layer 625 at another focal point is completed (step 607).

When the determination is made that the photography of another layer 625 at another focal point is not completed (No at step 607), the initial position of the XYZ stage of the optical microscope is regulated for the photography of another layer 625 (step 608). The XYZ stage transfers in the Z axial direction by a transfer amount specified by a user based on a control signal from the hardware controller of the CPU in the PC. As a result, the photography of a layer 625b shown in FIG. 26 is enabled. The method of changing the focal point for the photography of another layer 625 is not limited to the transfer of the XYZ stage. For example, the lens barrel of the optical microscope may be transferred in the Z axial direction or the imaging optical system may be regulated so that the focal point is changed.

The XYZ stage is transferred in the XY plane direction based on a control signal from the hardware controller. The XYZ stage is transferred based on the position coordinate of a standard photography region 635 of the layer 625 (corresponding to the first photography region 411 in the fourth embodiment). A position coordinate of the standard photography region 635b of the layer 625b is set so as to be offset by the sizes xL and yL in the X axial direction and the Y axial direction with respect to a position coordinate of a standard photography region 635a of the layer 625a photographed at a previous time as shown in FIG. 26. The processes at steps 602 to 606 shown in FIG. 25 are executed based on the position coordinate of the standard photography region 635b of the layer 625b so that the layer 625b is photographed. As a result, the layers 625a and 625b are photographed so that an overlapping region 645a of the layer 625a (corresponding to the first, second, and third overlapping regions 420, 440, and 440 in the fourth embodiment) and an overlapping region 645b of the layer 625b are not arranged on the same position on the XY plane.

After that, when another layer 625 is photographed, as shown by an arrow A in FIG. 26, the position coordinate of the standard photography region 635 of the layer 625 is offset by the sizes x_{L} and y_{L} in the X axial direction and the Y axial direction at step 608. The respective layers 625 are photographed based on the position coordinates of the respective standard photography regions 635.

When the determination is made at step 607 that another layer 625 at another focal point is photographed and the photography in three-dimensional space of XYZ is completed (Yes at step 607), the photography of the sample is terminated.

In the method of setting the shot layouts by means of the PC according to the sixth embodiment, when one sample is photographed a plurality of times at different focal points, the layers 625 are laid out for photography at the respective focal points. The respective layers 625 are laid out so that the respective overlapping regions 645 are not arranged on the same position on the XY plane. As a result, when one sample is photographed a plurality of times at different focal points, the excitation light or the like can be prevented from being emitted intensively to a specified region of the sample. As a result, deterioration in the sample to be photographed can be suppressed.

In the sixth embodiment, the position coordinate of the standard photography region 635 is set, and a position coordinate of another photography region 615 of the layers 625 is set based on the position coordinate of the standard photography region 635. That is to say, only the position coordinate of the standard photography region 635 may be suitably set. For this reason, a throughput of the CPU of the PC can be reduced, and the respective layers 625 can be photographed in a short processing time. However, the method of setting the position coordinates of other photography regions 615 of the respective layers 625 is not limited to that based on the position coordinate of the standard photography region 635.

In the sixth embodiment, the position coordinates of the standard photography regions 635 of the layers 625 is set so as to be offset by the sizes x_{L} and y_{L} in the X axial direction and the Y axial direction. However, the present application is not limited to this, the position coordinates of the standard photography regions 635 of the layers 625 may be appropriately set as long as the overlapping regions 645 of the layers 625 are not arranged on the same position. For example, the position coordinates of the standard photography regions 635 of the layers 625 may be appropriately set based on, for example, a shape of a sample to be photographed, the number of the layers 625 to be photographed, and the size of the respective overlapping regions 645.

In the process for setting the position coordinates of the photography regions of the layers described in the sixth embodiment, when the layers at different focal points are photographed, the overlapping regions of the layers are not arranged on the same position. This process can be applied to the above-mentioned other embodiments.

### Other Embodiments

Embodiments of the present application are not limited to the above-mentioned embodiments and the present application has various other embodiments.

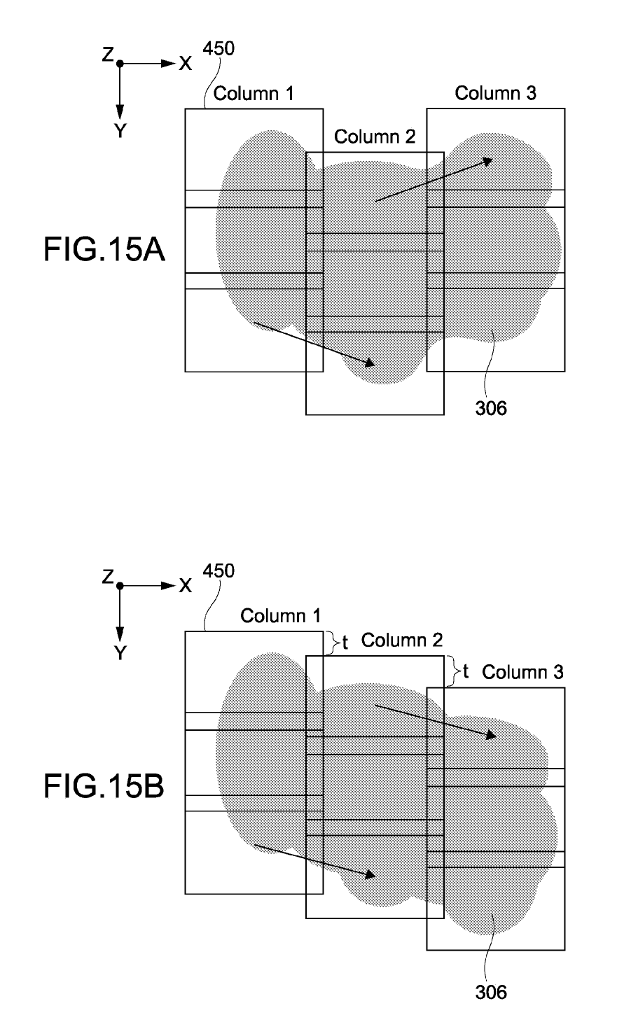

For example, FIGS. 15A and 15B are pattern diagrams illustrating an example of a shot layout of a plurality of photography regions 450 according to another embodiment. In FIG. 15A, the shot layout is set so that the plurality of photography regions 450 arranged on a first row (hereinafter, referred to as column 1) and the plurality of photography regions 450 arranged on a third row (column 3) are on the same position in the Y axial direction. After that, when a column 4 is arranged adjacently to the column 3, it is sufficient that the column 4 be arranged on the same position as that of the column 2 in the Y axial direction.

In FIG. 15B, the shot layout is set so that when the respective columns are arranged, each column is arranged on a lower side with respect to each left-side column by a predetermined size t in the Y axial direction. After that, when the column 4 is arranged, the column 4 may be arranged so as to be positioned on the lower side with respect to the column 3 by size t in the Y axial direction.

For example, the shot layouts shown in FIGS. 15A and 15B may be stored as defaults in the storage section of the information processing apparatus. The stored shot layouts as the default are appropriately used based on the entire shape of the sample 306 to be photographed, so that the photography time of the plurality of photography regions can be shortened.

In the respective embodiments, the PC as the information processing apparatus sets the shot layouts of the plurality of photography regions. However, the imaging apparatus 200 may set the above-mentioned shot layouts. Alternatively, for example a scanner apparatus having the function of the optical microscope is used as the imaging apparatus equipped with the optical microscope according to the embodiments of the present application, and the above-mentioned shot layout may be set by the imaging apparatus.

The present application is not limited to the case where an image obtained by the optical microscope is photographed, and can be applied to a case where photography regions having predetermined size are photographed by the imaging apparatus. That is to say, also when, for example, the photography is carried out without enlarging a fluorescent phenomenon of a tissue or the like by means of the optical microscope, the shot layouts described in the respective embodiments may be set by the imaging apparatus that photographs the tissue.

As shown in FIG. 1, an epifluorescent microscope was used as the optical microscope 300 according to the first embodiment. However, various fluorescent microscopes such as a transmission-type fluorescent microscope may be used. Further, microscopes such as a bright field microscope other than the fluorescent microscopes may be used as the optical microscope. For example, when a fluorescently unstained sample is enlarged by a bright field microscope and its image is photographed, illumination light is emitted to a photography region every time the photography region is photographed. As a result, even when the illumination light is not the excitation light, the sample is occasionally deteriorated. In such a case, the deterioration in the sample due to the illumination light can be suppressed by setting the shot layouts described in the respective embodiments.

The sizes of the first, second, and third overlapping regions and the overlapping regions between the adjacent columns described in the respective embodiments may be appropriately set every time the photography regions are photographed. For example, the plurality of the first overlapping region in the column 1 does not have the uniform size but may have different sizes. Similarly, the plurality of the second overlapping regions in the column 2 may have different sizes. The sizes of the plurality of first, second, and third overlapping regions are appropriately set based on the entire shape of the sample to be photographed, so that a necessary number of the photography regions can be reduced, and the photography time can be shortened.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An information processing apparatus, comprising:
a first setting means for setting respective position coordinates of a plurality of first photography regions arranged along a first direction of two axial directions orthogonal to each other, which are photographed by an imaging means capable of photographing photography regions having predetermined sizes in the two axial directions, so that the first photography regions adjacent to each other have first overlapping regions where the first photography regions overlap with each other in the first direction; and
a second setting means for setting respective position coordinates of a plurality of second photography regions arranged along the first direction based on the respective position coordinates of the plurality of first photography regions, which are set by the first setting means, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

2. The information processing apparatus according to claim 1, further comprising:
a detecting means capable of detecting a position coordinate of an edge portion of a subject to be photographed by the imaging means,
wherein the second setting means sets a position coordinate of a standard photography region being one of the plurality of the second photography regions based on the position coordinate of the edge portion detected by the detecting means, and sets the respective position coordinates of the plurality of second photography regions based on the position coordinate of the standard photography region.

3. The information processing apparatus according to claim 2, further comprising:
a selecting means for selecting one of a first direction setting pattern in which the first direction is set as a vertical direction and the second direction is set as a horizontal direction and a second direction setting pattern in which the first direction is set as the horizontal direction and the second direction is set as the vertical direction; and
a comparing means for comparing a period of time for photographing the plurality of first and second photography regions whose position coordinates are set to include the position coordinate of the edge portion of the subject detected by the detecting means when the selecting means selects the first direction setting pattern with a period of time for photographing the plurality of first and second photography regions whose position coordinates are set to include the position coordinate of the edge portion of the subject detected by the detecting means when the selecting means selects the second direction setting pattern.

4. An information processing method executed by an information processing apparatus comprising:
setting respective position coordinates of a plurality of first photography regions arranged along a first direction of two axial directions orthogonal to each other, which are photographed by an imaging means capable of photographing photography regions having predetermined sizes in the two axial directions, so that the first photography regions adjacent to each other have first overlapping regions where the first photography regions overlap with each other in the first direction; and
setting respective position coordinates of a plurality of second photography regions arranged along the first direction based on the respective set position coordinates of the plurality of first photography regions so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

5. A program causing an information processing apparatus to execute:
setting respective position coordinates of a plurality of first photography regions arranged along a first direction of two axial directions orthogonal to each other, which are photographed by an imaging means capable of photographing photography regions having predetermined sizes in the two axial directions, so that the first photography regions adjacent to each other have first overlapping regions where the first photography regions overlap with each other in the first direction; and
setting respective position coordinates of a plurality of second photography regions arranged along the first direction based on the respective set position coordinates of the plurality of first photography regions so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

6. An imaging apparatus, comprising:
an imaging means capable of photographing photography regions having predetermined sizes in two axial directions orthogonal to each other;
a first setting means for setting respective position coordinates of a plurality of first photography regions arranged along a first direction of the two axial directions, which are photographed by the imaging means, so that the first photography regions adjacent to each other have first overlapping regions where the first photography regions overlap with each other in the first direction; and
a second setting means for setting respective position coordinates of a plurality of second photography regions arranged along the first direction based on the respective position coordinates of the plurality of first photography regions, which are set by the first setting means, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

7. An imaging apparatus equipped with an optical microscope, comprising:
an optical microscope including an illumination optical system, a stage, and an imaging optical system, the stage having an observation region provided onto an optical path of the illumination optical system and being movable in two axial directions orthogonal to each other, the imaging optical system imaging photography regions arranged within the observation region and having predetermined sizes in the two axial directions;
an imaging means capable of photographing images of the photography regions imaged by the imaging optical system;
a transfer controlling means for controlling transfer of the stage in order to change positions of the photography regions with respect to the observation region;
a first setting means for setting respective position coordinates of a plurality of first photography regions arranged along a first direction of the two axial directions which are imaged by the imaging optical system so that the first photography regions adjacent to each other have first overlapping regions where the first photography regions overlap with each other in the first direction;
a second setting means for setting respective position coordinates of a plurality of second photography regions arranged along the first direction based on the respective position coordinates of the plurality of first photography regions, which are set by the first setting means, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions; and
an output means for outputting information about the respective position coordinates of the plurality of first photography regions, which are set by the first setting means, and information about the respective position coordinates of the plurality of second photography regions, which are set by the second setting means to the transfer controlling means.

8. An information processing apparatus, comprising:
a first setting means for setting respective position coordinates of first photography regions and second photography regions arranged in a first direction of two axial directions orthogonal to each other, which are photographed by an imaging means capable of photographing photography regions having predetermined sizes in the two axial directions, so that the first and second photography regions have first overlapping regions where the first and second photography regions overlap with each other in the first direction, and respective position coordinates of the first and second photography regions in a second direction of the two axial directions, which is different from the first direction, are different from each other; and
a second setting means for setting respective position coordinates of third photography regions and fourth photography regions arranged in the first direction based on the respective position coordinates of the first and second photography regions, which are set by the first setting means, so that the third and fourth photography regions have second overlapping regions where the third and fourth photography regions overlap with each other in the first direction, the third and fourth photography regions overlap with the first and second photography regions in the second direction on third overlapping regions, and respective position coordinates of the third and fourth photography regions in the second direction are made to be different from each other, to thereby prevent the first, second, and third overlapping regions from overlapping with each other.

9. An information processing method executed by an information processing apparatus comprising:
setting respective position coordinates of first photography regions and second photography regions arranged in a first direction of two axial directions orthogonal to each other, which are photographed by an imaging means capable of photographing photography regions having predetermined sizes in the two axial directions, so that the first and second photography regions have first overlapping regions where the first and second photography regions overlap with each other in the first direction, and respective position coordinates of the first and second photography regions in a second direction of the two axial directions, which is different from the first direction, are different from each other; and
setting respective position coordinates of third photography regions and fourth photography regions arranged in the first direction based on the respective set position coordinates of the first and second photography regions so that the third and fourth photography regions have second overlapping regions where the third and fourth photography regions overlap with each other in the first direction, the third and fourth photography regions overlap with the first and second photography regions in the second direction on third overlapping regions, and respective position coordinates of the third and fourth photography regions in the second direction are made to be different from each other, to thereby prevent the first, second, and third overlapping regions from overlapping with each other.

10. A program causing an information processing apparatus to execute:
setting respective position coordinates of first photography regions and second photography regions arranged in a first direction of two axial directions orthogonal to each other, which are photographed by an imaging means capable of photographing photography regions having predetermined sizes in the two axial directions, so that the first and second photography regions have first overlapping regions where the first and second photography regions overlap with each other in the first direction, and respective position coordinates of the first and second photography regions in a second direction of the two axial directions, which is different from the first direction, are different from each other; and
setting respective position coordinates of third photography regions and fourth photography regions arranged in the first direction based on the respective set position coordinates of the first and second photography regions so that the third and fourth photography regions have second overlapping regions where the third and fourth photography regions overlap with each other in the first direction, the third and fourth photography regions overlap with the first and second photography regions in the second direction on third overlapping regions, and respective position coordinates of the third and fourth photography regions in the second direction are made to be different from each other, to thereby prevent the first, second, and third overlapping regions from overlapping with each other.

11. An information processing apparatus, comprising:
a first setting unit configured to set respective position coordinates of a plurality of first photography regions arranged along a first direction of two axial directions orthogonal to each other, which are photographed by an imaging unit capable of photographing photography regions having predetermined sizes in the two axial directions, so that the first photography regions adjacent to each other have first overlapping regions where the first photography regions overlap with each other in the first direction; and
a second setting unit configured to set respective position coordinates of a plurality of second photography regions arranged along the first direction based on the respective position coordinates of the plurality of first photography regions, which are set by the first setting unit, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

12. An imaging apparatus, comprising:
an imaging unit capable of photographing photography regions having predetermined sizes in two axial directions orthogonal to each other;
a first setting unit configured to set respective position coordinates of a plurality of first photography regions arranged along a first direction of the two axial directions, which are photographed by the imaging unit, so that the first photography regions adjacent to each other have first overlapping regions where the first photography regions overlap with each other in the first direction; and
a second setting unit configured to set respective position coordinates of a plurality of second photography regions arranged along the first direction based on the respective position coordinates of the plurality of first photography regions, which are set by the first setting unit, so that the second photography regions adjacent to each other have second overlapping regions where the second photography regions overlap with each other in the first direction, the plurality of second photography regions overlap with the plurality of first photography regions in a second direction of the two axial directions, which is different from the first direction, and the second overlapping regions are prevented from overlapping with the first overlapping regions.

13. An information processing apparatus, comprising:
a first setting unit configured to set respective position coordinates of first photography regions and second photography regions arranged in a first direction of two axial directions orthogonal to each other, which are photographed by an imaging unit capable of photographing photography regions having predetermined sizes in the two axial directions, so that the first and second photography regions have first overlapping regions where the first and second photography regions overlap with each other in the first direction, and respective position coordinates of the first and second photography regions in a second direction of the two axial directions, which is different from the first direction, are different from each other; and
a second setting configured to set respective position coordinates of third photography regions and fourth photography regions arranged in the first direction based on the respective position coordinates of the first and second photography regions, which are set by the first setting unit, so that the third and fourth photography regions have second overlapping regions where the third and fourth photography regions overlap with each other in the first direction, the third and fourth photography regions overlap with the first and second photography regions in the second direction on third overlapping regions, and respective position coordinates of the third and fourth photography regions in the second direction are made to be different from each other, to thereby prevent the first, second, and third overlapping regions from overlapping with each other.
